(19) United States
(12) Patent Application Publication
(10) Pub. No.: US 2022/0025161 A1
(43) Pub. Date: Jan. 27, 2022

(54) Biodegradable elastomeric film composition and method for producing the same

(71) Applicants: Avadiar MUTHUSAMY, Seremban (MY); Kunasagaran APPAVOO, Pulau Pinang (MY)

(72) Inventors: Avadiar MUTHUSAMY, Seremban (MY); Kunasagaran APPAVOO, Pulau Pinang (MY)

(21) Appl. No.: 17/492,673

(22) Filed: Oct. 3, 2021

Related U.S. Application Data
(62) Division of application No. 15/763,453, filed on Mar. 27, 2018.

(30) Foreign Application Priority Data
Oct. 9, 2017 (MY) PI2017001493

(51) Int. Cl. C08L 9/04; C08L 11/02; B29C 41/14; B29C 41/34; C08K 3/013; C08K 3/22

(52) U.S. Cl. CPC C08L 9/04; C08L 11/02; B29C 41/14; B29L 2031/4864; C08K 3/013; C08K 3/22; B29C 41/34

(57) ABSTRACT

The invention relates to a method to manufacture an elastomeric article includes preparing a former for shaping the elastomeric article; dipping the former into a coagulant solution which including one or more one or more polyvalent metal salt, surfactant, wetting agents, anti-tack materials, non-settling agents, and biocide; dipping the coagulant-coated former into a synthetic latex composition from 20° C. to 40° C. at least once to create the elastomeric article; pre-leaching the elastomeric article for not more than 10 times; vulcanizing the elastomeric article to enable effective crosslinking; surface treating the vulcanized elastomeric article form 60° C. to 140° C.; post-leaching the elastomeric article at temperature of 30° C. to 95° C.; applying donning aid to the elastomeric article; drying the elastomeric article; and stripping the elastomeric article from the former. The elastomeric article has a thickness of 0.001 to 5 mm, a minimum tensile strength of 7 MPa, and an elongation above 300%.

### CROSS-REFERENCE TO RELATED APPLICATIONS

This application is a division of U.S. patent application Ser. No. 15/763,453 filed on Mar. 27, 2018, which is a 371 national phase application of international patent application PCT/MY2017/050076 filed on Nov. 28, 2017, which claims priority to Malaysia patent application no. PI2017001493 filed on Oct. 9, 2017; the disclosures of which are incorporated herein by reference in their entirety.

### TECHNICAL FIELD

The invention relates to an elastomeric film composition and methods for manufacturing the elastomeric film, more particularly manufacturing an elastomeric article with biodegradable properties.

### BACKGROUND

Gloves may be used in medical applications, electronics, food or sanitation to provide adequate protection from bacteria, viruses and other potential contaminants. Commercial gloves are made from impervious elastomeric film, wherein synthetic latex material makes the bulk of the elastomeric film composition. The use of synthetic latex material eliminates Type I allergy caused by presence of protein in natural rubber latex.

Dipping technology for fabrication of gloves has evolved from solvent-based dipping to aqueous dipping. Commercial dipping involves solid rubber molecules and curatives dispersed in aqueous media such as water. However, chemicals constituents undergo only minor modifications with respect to the particle size by milling and dispersions.

WO 2011068394 A1 described a process to produce elastomeric gloves without sulphur and accelerators. A mixture of carboxylated acrylonitrile butadiene latex, methacrylic acid and zinc oxide ensured creation of crosslinking properties to reduce inert chemicals. pH levels of the mixture were maintained at 9-10 with alkali substance such as potassium hydroxide at 0.1 to 2% w/w of carboxylated acrylonitrile butadiene latex. The invention solves common glove allergies by replacing natural rubber and accelerators with alternatives in the gloves composition. The prior art however did not discuss about reducing chemical consumption for elastomeric glove production.

WO 2016072835 A1 described an elastomeric film composition comprising at least one base polymer, a cross-linking agent, and a pH adjustor. A method for producing said elastomeric film without conventional metal oxide was disclosed as well. The elastomeric film composition comprises an admixture of trivalent metal selected from aluminium, iron (III) and chromium (III) compound, polyethylene glycol, hydroxide salt and water. The elastomeric film produced by this method display mechanical properties such as film thickness at 0.06-0.07 mm, 31-41 MPa tensile strength, and 4.5-6.4 MPa with modulus at 300%. The prior art also mitigates allergies commonly found in natural latex gloves. However, the consumption of synthetic latex remains the same.

US20170218168A1 disclosed a method to produce synthetic elastomeric article with reduced consumption of multivalent metal complex ion yet retaining conventional mechanical properties such as tensile strength or modulus. The synthetic elastomeric article composition comprises a synthetic carboxylated polymer and a crosslinking composition. The crosslinking composition is prepared with proper solubilization of multivalent metal under significant amount of alkali, activation of multivalent metal in solubilized complex form allows for a reduced number of multivalent ions used in the composition yet achieving an excellent degree of crosslinking. However, gloves made with pure synthetic materials are often disposed through incineration.

Accordingly, it can be seen in the prior art that there exists a need to manufacture gloves with biodegradable properties.

### SUMMARY OF THE INVENTION

It is an objective of the present invention to provide an elastomeric article with biodegradable properties.

It is also an objective of the present invention to provide a cured synthetic latex composition that provides the elastomeric article biodegradable properties.

It is yet another objective of the present invention to provide a method to manufacture the elastomeric article with biodegradable properties.

The invention relates to an elastomeric article made from a cured product of synthetic latex composition, characterized by a base polymer; a solubilized polyvalent metal hydroxide having a pH above 9.0 at a range of 0.0001 to 0.20 phr; a milled polyvalent metal oxide; an alkali solution for solubilizing the polyvalent metal hydroxide; and fillers at 0.5 phr minimum for manufacturing the elastomeric article with biodegradable properties; wherein said elastomeric article having thickness of 0.001 to 5 mm; tensile strength of 7 MPa; and elongation of 300% minimum. The invention also relates to the method to manufacture the elastomeric article, comprising preparing a former for shaping the elastomeric article; dipping the former into a coagulant solution; drying the coagulant-coated former; dipping the dried coagulant-coated former into a synthetic latex composition to create the elastomeric article; followed by pre-leaching; vulcanizing; surface treating; applying donning aid; drying and stripping the elastomeric article from the former.

### DETAILED DESCRIPTION OF THE INVENTION

It is to be understood that the detailed description merely provides an exemplary and explanatory technical solutions of the present invention, but not intended to limit the present invention but a basis for claims. The terms “include”, “including”, “comprise”, “comprising” shall be understood to be open terms and not meant to be limited. The invention is to cover all modifications, equivalents, and alternatives made against the technical solutions or features described in the embodiments, as long as such modifications, equivalents, and alternatives does not depart from the scope of the present invention. Where abbreviations of technical terms are used, these indicate commonly accepted meaning as known in the technical field.

The invention relates to an elastomeric article made from a cured product of synthetic latex composition, characterized by:
a base polymer;
a solubilized polyvalent metal hydroxide having a pH above 9.0 at a range of 0.0001 to 0.20 phr;
a milled polyvalent metal oxide at a range of 0 to 0.45 phr;
an alkali solution for solubilizing the polyvalent metal hydroxide; and
fillers at 0.5 phr minimum for manufacturing an elastomeric article with biodegradable properties, wherein said elastomeric article having thickness of 0.001 to 5 mm, tensile strength of 7 MPa; and elongation of 300% minimum.

In a preferred embodiment of the elastomeric article, the base polymer is carboxylated acrylonitrile latex.

In a further embodiment of the base polymer, wherein carboxylation level of the base polymer is within the range of 0.001 to 12%.

In another embodiment of the elastomeric article, wherein the base polymer is selected from the group of carboxylated synthetic polymer consisting one or a combination of:
carboxylated acrylonitrile butadiene;
styrene butadiene;
carboxylated styrene butadiene;
polychlorobutadiene;
polydichlorobutadiene;
butyl rubber;
polyisoprene;
polyvinyl chloride;
polybutadiene;
polyurethane;
polyacrylic; and
styrene copolymer.

In yet another embodiment of the elastomeric article, wherein natural rubber latex is added into the base polymer composition for non-Type-1 allergic glove users.

In a preferred embodiment of the elastomeric article, the solubilized polyvalent metal hydroxide is polyvalent zinc hydroxide.

In another embodiment of the elastomeric article, wherein the solubilized polyvalent metal hydroxide is selected from the group of polyvalent metal hydroxide consisting one or a combination of a divalent metal hydroxide; and a trivalent metal hydroxide.

In a preferred embodiment of the elastomeric polymer, the solubilized polyvalent metal hydroxide is zinc hydroxide at the range of 0.0001-0.2 phr.

In another embodiment of the elastomeric article, wherein the polyvalent metal hydroxide is selected from the group of polyvalent metal hydroxide consisting one or a combination of:
zinc;
calcium;
magnesium;
chromium;
vanadium;
   beryllium; and
   aluminium.

In another embodiment of the elastomeric article, wherein the polyvalent metal hydroxide composition contains insolubilized polyvalent metal hydroxide at the range of 0-0.3 phr.

In a preferred embodiment of the elastomeric article, the milled polyvalent metal oxide is zinc oxide.

In one embodiment of the elastomeric article, wherein the milled polyvalent metal oxide is selected from the group of polyvalent metal oxide consisting one or a combination of:
zinc;
calcium;
magnesium;
chromium;
vanadium;
beryllium; and
aluminium.

In a preferred embodiment of the elastomeric article, the preferred alkali solution is a combination of sodium and potassium hydroxide solution.

An embodiment of the elastomeric article, wherein the alkali solution is selected from the group of alkali solution comprising one or a mixture of:
sodium hydroxide;
potassium hydroxide;
lithium hydroxide; and
ammonia.

In a preferred embodiment of the elastomeric article, the filler added to the synthetic latex composition is the organic filler.

Another embodiment of the elastomeric article, wherein the filler is selected from the group of filler comprising one or a combination of
organic fillers; and
inorganic fillers.

An embodiment of the elastomeric article, wherein the organic filler is selected from the group of organic fillers consisting one or a combination of:
starch derivatives;
cellulose derivatives;
biodegradable additives;
polybutylene succinate;
polycaprolactone;
polyanhydrides; and
polyvinyl alcohol.

An embodiment of the elastomeric article, wherein the inorganic filler is selected from the group of inorganic filler consisting one or a combination of:
calcium carbonate;
carbon black;
titanium dioxide;
bauxite;
barytes;
clay;
kaolinite;
montmorillonite; and
illite.

In an embodiment of the elastomeric article, wherein the synthetic latex composition contains additional crosslinking agent, comprising one or a combination of
solid polyvalent metal oxide;
elemental sulphur;
soluble sulphur; and

sulphur-based accelerators.

Further embodiment of the elastomeric article, wherein sulphur-based accelerators comprising one or a combination of thiocarbamates (ZDBC, ZDEC);
guanidines (DPG);
thiazoles (ZMBT);
thiourea (DPTU); and thiuram polysulfides (DPTT).

In an embodiment of the elastomeric article, wherein the cured product of synthetic latex composition is free from sulphur and sulphur-donor accelerator.

The invention also relates to a method to manufacture an elastomeric article, comprising preparing a former for shaping the elastomeric article;
dipping the former into a coagulant solution;
drying the coagulant-coated former;

dipping the dried coagulant-coated former into a synthetic latex composition at least once to create the elastomeric article;

pre-leaching the elastomeric article;

vulcanizing the post-leached elastomeric film to enable effective crosslinking;

surface treating the vulcanized elastomeric article;

applying donning aid to the elastomeric article;

drying the elastomeric article; and

stripping the elastomeric article from the former.

In a preferred embodiment of the method to manufacture the elastomeric article, wherein cleaning the former prior to dipping into the coagulant solution to remove residual material adhering the former.

A further embodiment of the method to manufacture the elastomeric article, wherein drying the cleaned former at temperatures up to 150 degrees Celsius.

In a preferred embodiment of the method to manufacture the elastomeric article, wherein said cleaning is a cleaning system providing elevated bath temperatures of 50 to 95 degrees Celsius.

In a preferred embodiment of the method to manufacture the elastomeric article, wherein preparing said coagulant solution by mixing polyvalent metal salt, surfactant, and wetting agents.

In another embodiment of the method to manufacture the elastomeric article, wherein said coagulant solution by mixing polyvalent metal salt, surfactant, wetting agents, and anti-tack materials.

In an embodiment of the method to manufacture the elastomeric article, wherein the number of dipping said former into the coagulant solution may be between 1-8.

In an embodiment of the method to manufacture the elastomeric article, wherein dipping the former into the coagulant solution for the first time and subsequently dipping in synthetic latex composition creates the elastomeric article.

In an embodiment of the method to manufacture the elastomeric article, wherein dipping the elastomeric article into the coagulant solution and the synthetic latex composition multiple times to increase thickness of the elastomeric article.

In a preferred embodiment of the method to manufacture the elastomeric article, wherein the coagulant-coated former is dried with an air-circulated oven system.

In a preferred embodiment of the method to manufacture the elastomeric article, wherein the pre-leaching of the elastomeric article is conducted as much as 10 rounds.

In an embodiment of the method to manufacture the elastomeric article, wherein the pre-leached elastomeric article is coated in polymer.

In another embodiment of the method to manufacture the elastomeric article, wherein the pre-leached elastomeric article is beaded thereafter.

In another embodiment of the method to manufacture the elastomeric article, wherein the vulcanized elastomeric article is chlorinated.

In yet another embodiment of the method to manufacture the elastomeric article, wherein the vulcanized elastomeric article is neutralized.

In a further embodiment of vulcanized elastomeric film, wherein the chlorinated and neutralized elastomeric article is coated with donning aids.

In an embodiment of the method to manufacture the elastomeric article, wherein the dried elastomeric article is stripped off the former manually.

In another preferred embodiment of the method to manufacture the elastomeric article, wherein the dried elastomeric article is stripped off the former mechanically.

The following description describes the invention in detail with reference to non-limiting embodiments.

In a conventional curing system followed by the synthetic elastomeric film forming articles, the addition of fillers to the synthetic elastomeric compounds is low or not added at all. The main reason is said synthetic elastomeric film forming articles with added fillers becomes tough and display high modulus values even at low level of additions.

The use of polyvalent metal hydroxide in general reduces chemical consumption to produce synthetic elastomeric articles. Reduction of chemical consumption is possible with conventional ionic crosslinker such as zinc, thus benefit towards building a green and eco-friendly environment with reduced amount of chemical pollutant.

In the present invention, proper solubilization and conditioning of zinc oxide enables chemical consumption reduction to 5/10000 of conventional zinc oxide consumed in the carboxylated synthetic butadiene latex. Theoretically, a reduction as low as 1/10000 to conventional chemical consumption is possible.

The alkali solution chosen for making and maintaining the hydroxide form can be selected from one or a combination comprising sodium hydroxide, potassium hydroxide, lithium hydroxide and ammonia. The preferred embodiment for the alkali solution is the combination of sodium and potassium hydroxide. In another embodiment, lithium may be used for more aggressive conditions.

The higher the amount of alkaline earth oxide or alkaline earth hydroxide ratio is preferred as the alkaline earth oxide or alkaline earth hydroxide in turn provides better performance. An optimum value for the amount of alkaline earth oxide or alkaline earth hydroxide to be used is up to 400 multiple times or more of the intended alkali hydroxide solution, wherein any excess alkali solution acts as pH stabilizer of the overall latex.

Free zinc metal ions is made available with adding excess alkaline solutions to divalent zinc hydroxide. The mixture may undergo heating if required. The same process to obtain free zinc metal ions can be applied towards trivalent metal hydroxide. The excess alkaline gives a dynamic electrostatic stability to the zinc ions and preserve the reactivity or reaction ability of the positive ions of the divalent metal. The sodium may form an intermediate such as sodium zincate, however attention is given to the existence of nascent divalent metal ion.

Excessive loading of ionic crosslinker makes the elastomeric film tough. Furthermore, with the additional loading of fillers, the elastomeric film is tougher. Tough elastomeric film causes fatigue of fingers and feels quite uncomfortable after a prolonged wearing.

Low consumption of ionic crosslinker produces elastomeric film with low modulus, hence enables additional loading of filler for optimized strength, modulus and elongation. With the addition of filler, fingers less likely to be strained during prolonged wear. By adjusting the amount of filler, various national and international standard requirements with respect to the strength, modulus and elongation properties can be met.

Compounding

The main component is the carboxylated synthetic butadiene elastomer which is a copolymer consists of carboxylic acid or its derivative and butadiene building block either alone or in combination such as nitrile butadiene, chlorobutadiene, methyl-Isoprene, styrene butadiene and others conjugated with basic butadiene.

The latex is received in colloidal dispersion form wherein polymeric bundles or sub-micro rubber particles are dispersed in water with suitable stabilizers and emulsifiers. The polymeric macro molecules is in anionic form with pH above 7.5. Premature cohesion or reaction between individual particles leads to micro lump formation, which weaken the elastomeric film. It is important to have non-contaminated water such as soft water or demineralized water. The pH of water could be adjusted before addition to suit synthetic latex and thus avoiding pH shock.

In the basic butadiene structure, the unsaturated double bond structure is the key component which forms the polymeric structure. By keeping the unsaturated double structure un-reacted leads to an effective final film formation. Apart from the unsaturated diene structure, the attached carboxylic acid functional group provides an effective reactive site. This reactive site reacts with polyvalent metal to form a continuous chain with other sub polymeric groups, hence forming a macro molecule or elastomeric film.

The reaction with the carboxylic site of the polymer is a condensation reaction where water is released when the acid portion is neutralized with alkaline component. Said ionic reaction is simple and even could take place in room temperature without much support from heating or other energy sources, whereas breaking of butadiene bonds and attaching with sulphur or covalent bonds requires lot of energy and high temperature and it has been practiced in the industry for centuries. The ionic reaction with less energy supply was commercialized in a big way in the past two decades especially in the making of nitrile rubber gloves using carboxylated nitrile butadiene rubber. In the present invention, utilization of Nano-technology in the rubber reaction was utilized for substantially less quantity and less energy.

Soluble trivalent metal hydroxide is prepared by mixing trivalent metal oxide with sodium hydroxide and potassium hydroxide in ratio of 1:3:2. The mixture undergoes heating at temperatures above 120 degrees Celsius in a stainless-steel vessel. The resultant mixture is cooled and dissolved in water to get soluble trivalent metal hydroxide. To sustain solubility of the trivalent metal hydroxide, the recommended pH level must be above 10.

In the case of soluble divalent metal hydroxide, the divalent metal oxide is heated up with at least twice the amount of sodium hydroxide and potassium hydroxide and lithium hydroxide mixture or more. After that, the mixture must be dissolved in water.

Conventional additives such as sulphur, accelerators, pigments, opaqueness provider, anti-oxidants, anti-ozonates such as waxes, surfactants, pH stabilizers, secondary polymers may be added during the making of compounds for dipping process.

The anti-oxidant used in the present invention is hindered phenols or cresols. In the absence of anti-oxidant, the atmospheric oxygen may rupture the crosslinking bonds. Anti-oxidant absorbs the oxygen by reacting with the active oxygen and form a protective layer over the cross-linking bonds. As a result, rate of oxidation is slowed down thus slows the deterioration of the elastomeric film.

All the water-insoluble materials such as metallic oxide, anti-oxidant, pigment, fillers, sulphur, and accelerator are grounded to preferably below 5 microns in particle size to ensure uniform film production. The milling of water-insoluble materials could be done by conventional ball mill or other types of fine pulveriser. During milling, non-foaming surfactants such as sodium salt of naphthalene-sulphonic acid condensation products is added into the mixture. The non-foaming surfactants acts as a wetting agent and prevents agglomeration of the milled particles. pH stabilizers are also added such as ammonium hydroxide or potassium hydroxide or sodium hydroxide. Said alkali solutions ensure required pH level in line with the latex emulsion which is normally anionic in nature. The particles size is determined by the duration of milling, the flow rate of feeding to the mill and equipment capability. For prolonged storage it is better to have minor amount of biocide to prevent any bacterial attack.

In the case of milling fillers, it is better to have minimal biocide say 0.001% or 0.0001% to the total solids content. Method of milling water-insoluble materials are applicable to the method of milling of fillers. It is advisable to keep the filler in constant stirring and check the total colony forming units.

The precipitated calcium carbonate has less settling tendency than the milled clay materials. However, addition of thickeners and anti-settling agents reduces the settling tendency.

Soluble accelerators and sulphur are available but they are costlier and not economical to use in the bulk production.

The normal steps of compounding comprising adding pH stabilizer into the latex into water.

Optionally, surfactants are added to the mixture. If multiple latex is present, the step is repeated as along suitable pH stabilization is available. Then the curatives and other milled components excluding filler is added. In case of multiple latex, the latex could be individually compounded and added up at the end however it depends on the nature of individual latexes.

Filler is added after 8 hours of completion of all other additives or 4 hours before the release. Fillers should be diluted before adding in to the elastomer portion to avoid coagulation or localized lump formation.

Once the other component additions are made, residual water is added at the end to adjust total solid content. As the normal practice, lower weight product has lower total solid content and vice versa. Separate latex dipping tanks could be necessary for higher thick products or multiple combinations of various latexes in each layer.

The maturation time is the duration between the times of curative addition to the compound to the time of releasing the compound to the dipping line. Swelling index is measured by the difference in the diameter of the film to the original diameter of the film before immersing in the solvent, Toluene, THF, acetone, IPA or other oils recommended by the international standards.

The parameters to control at compounding would be maturation time, swelling index, total solid content, pH, colour and formation or presence of micro-floc. In the case of unusual micro-flocking, the latex could be filtered using the suitable size filter starting from 80, 100, 200 or higher mesh. The other process chemicals like cleaning aids and coagulants could also be prepared in the compounding.

The coagulant is prepared in steps according to the ingredients present. Normally, solubilized calcium nitrate is added with suitable anti-tack material and wetting agents. Preferably a 24-hour maturation for coagulant solution to remove bubble and conditioning of anti-tack with calcium nitrate.

Depending on the required elastomeric properties, the polymer solution preparation or the donning agent polymer used before vulcanization may be diluted with suitable treated water. In other embodiments of the elastomeric article, the polymer solution preparation is added with surfactants.

Depending on the pick-up required, thickener is added into the polymer solution preparation.

Cleaning Series

The cleaning series and the chemical used and the brushing system and the temperature controls are the vital aspects for a better cleaning of the former which in turn vital for better film formation and in turn vital for better quality of film with minimal or zero pin-hole defects.

Normally acid and alkali are used in the cleaning process as chemical cleaning agents along with mechanical cleaning by brushes.

Acid could be selected from nitric acid, sulphuric acid, phosphoric acid, acetic acid, chromic acid, hydrochloric acid and other inorganic or organic acids or the combinations of the above stated acid in a suitable proposition required by the prevailing condition, which is the former dirt or stain load and the targeted cleaning condition.

Generally, acid solubilizes the adhering carbonate residues and other metallic residues either by double decomposition reaction or converting to respective metal salt and thus solubilizing. The acid concentration could be varied from 0.3% to 30% depending on the cleanliness level required and the type of acid chosen. The weaker organic acid could be used at higher concentrations and the strong inorganic acids could be used in lower concentration. Normally the higher concentration acid poured slowly to the water with adequate cooling and venting systems. In any circumstances, the addition should be as slow as possible, preferably it should be dripped slowly rather than pouring in. For effective cleaning the bath temperature must be at 35-80 degrees Celsius.

The alkali could be chosen from sodium hydroxide, potassium hydroxide, lithium hydroxide, alkaline salts, ammonia, tri-ethanolamine, di-ethanolamine or other hydroxide supplying chemicals or the mixtures thereof. The normal concentrations used or 0.2%-20% depending the severity of the alkalinity of the alkaline cleaner chosen, as logically high active material could be used in lower dosages and vice versa. In case of solubilizing high concentration solid alkaline material, the addition should be slow and proper cooling is required since the dissolution is exothermic. For effective cleaning, the bath temperature must be at 35-90 degrees Celsius.

Next, the formers be immersed in acid tanks. After the acid tanks, it is preferable to rinse the former with hot or ambient water before rising the former in alkaline tank thereafter. There could be a brush cleaning before going in for alkaline cleaning. For effective cleaning, the bath temperature should be at 35-80 degrees Celsius.

The brush cleaning could be designed in such a way to cover all the area of the mould. The brush could be dripped or sprayed with water to remove the adhering dirt collected from the formers. The last tank should be water filled and maintained preferably at higher temperature of 50-95 degrees Celsius.

The cleanliness of the tanks and periodical purging is necessary for effective cleaning process. Normally heating be done by providing heating coils or direct firing if metal tanks are used. In some cases, surfactants are used to improve the cleaning at varying percentage from 0.02 to 2% depending on the surfactant chosen.

Other organic cleaners containing chlorinated hydro-carbons, mixed organic solvents combinations, and other solubilizing polymeric material available in the market could be used.

Former Drying

After the cleaning cycle is over the formers are dried by blowing ambient temperature air or pass through an oven with suitable hot air circulation using ducts with distribution arrangements. This step avoids building excess water during coagulant dipping.

In the case of hot air circulation, the air temperature could be from 110-250 degrees Celsius. The temperature selection depends upon the prevailing ambient temperature and humidity of the atmospheric air. It is preferable that the former is clean and dry before dipping into the coagulant cum anti tack solution.

Coagulant Dipping

The coagulant bath contains salts which upon dissociation in water provide cationic metal ions which are capable of depositing anionic latex particles on the former. Normally divalent salts used such as calcium nitrate, calcium chloride and other salts of similar characteristics to enable deposition of rubber particles on the mould.

The coagulant bath basically contains few vital components, polyvalent metal salt, anti-tack material, surfactant, wetting agent and optionally other non-settling agents like thickeners of natural or synthetic source or combinations thereof. In some cases, anti-tack is optional where the former surface is smooth and water stripped. However, the wetting agent plays a vital role in the film formation by properly coating the salt and anti-tack material on the mould.

The anti-tack could be of two types viz., insoluble inorganic powder type such as calcium carbonate, magnesium carbonate, and talc; or fine inorganic salt or salt complexes without any ionic activity. They could be used individually or in combination with sparingly soluble soap type like metallic stearates, laurates, oleates or the combinations thereof.

The surfactant or wetting agent could be Octyl phenolic compounds. The dosage of surfactant could be 0.01-0.15 phr or more.

The coagulant bath could be higher than the ambient 40 degrees Celsius-70 degrees Celsius. In some cases, preferably 50-55 degrees Celsius. The temperature range is selected in such a way the coating materials are synchronized to provide a uniform salt and anti-tack coating on the former.

Since insoluble materials are involved in the bath, there is likelihood chance of settling at the bottom or floating on the top. To avoid such homogeneity issues, the tank is designed in such a way for circulation of the coagulant using suitable pump and circulation mechanism, filters are provided to filter off any dirt or foamy material generated while dispersing the metallic stearates.

The number of coagulant dipping could vary from 0 to 4 depending upon the thickness profile and nature of the product. In some instances, the additional coagulant dipping could be after the latex coating which is intended to enable the uniform and thicker coating of the film in the subsequent stages after coagulant dipping. As such, the thickness of the product is high and with features like latex types, latex characteristics, and filler content such in-between coats are warranted.

In some cases, addition of anti-foaming agent is warranted to eliminate bubbles in the batch. The addition could be less between 0.0001 to 0.01% depending the material and the amount of bubbles and webbing between fingers of the former while exit from the bath.

Coagulant Drying

The former dipped with coagulant could be dried using suitable drying system preferably using an air circulated oven system, any other system of drying the coagulant coated formers are also could be chosen depending on the necessity. For example, the availability of natural gas is higher and cheaper the formers could be heated up directly by placing the burners underneath the travelling path of the formers, however proper care should be taken to avoid spot heating and uniform heating should be ensured.

In the case of hot air circulation, the air temperature could be from 110-250 degrees Celsius. The temperature selection depends upon the prevailing ambient temperature and humidity of the atmospheric air. It is preferable that the coagulant coating could be sufficiently dried before dipping into the latex tank.

Latex Dipping

There quite few basic things which are to be controlled to get good quality product. The proper flow of the latex compound inside the tank is essential which is to ensure the proper film formation and avoiding the settlement of solid material in the bottom of the tank. The direction of latex flow should be along with the same direction of the former movement.

The latex bath temperature is important to enable proper latex stability, at higher temperature the latex may start coagulating hence formation of micro lump. It is preferable to keep at 20 degrees Celsius for sensitive latex composition, it can go up to 40 degrees Celsius when the total solid content is less and where there is a subsequent latex dipping is planned. The dried coagulant or anti-tack coated former could be dipped in latex compound. For higher film thickness above 40 micron, number of dips could be more than one depending on the latex pick up in each dip.

The control parameters are latex total solid content, pH, temperature, viscosity, visual like colour separation or lump formation, dripping of coagulant or serum from the previous dipping. Total solid content is important to decide the weight of the product.

Based on the cost factor, the layering of different dips from the previous dipping bath could vary with respect to the type of latex or the amount of filler containing in the compositions.

In case of multilayer dipping coagulant coating could be provided to enable higher and uniform film pick up. The coagulant concentration could be varied upon the final thickness requirement. It is essential to provide air drying between the dips so that the residual serum is not contaminating the subsequent latex bath.

Gelling Oven

The function of the gelling oven is to control the moisture level or the water content of the film before going to the next station. The next station could be another dip in the coagulant or another latex bath, or pre-leaching.

Drying or gelling of the film could be affected by hot air circulation the air temperature could be from 110-250 degrees Celsius. The temperature selection depends upon the prevailing ambient temperature and humidity of the atmospheric air and the extent of gelling expected. It is preferable that the film could be sufficiently dried. The insufficient drying may carry serum to the next tank or result in washing away of the film during pre-leaching thereafter.

Pre Leaching

After final latex dip, the film is partially dried and pre-leached, the number pre-leaching stations could be from 0-10. In the case of pre-leaching, the number of pre-leaching tanks and the temperature of the pre-leaching bath and the flow rate are important aspects.

The purpose of pre-leaching is to eliminate the soluble content in the formulation. More specifically the surfactants and wetting agent or stabilizers are to be removed to the extent possible to ensure it does not comes out in storage of the product and cause sticky or cause allergic to the end user. The level of the dipping of the film is decided depending on the condition of the edge of the film at cuff area which determines the beading quality.

The control parameters are temperature of the pre-leaching tanks between 30-70 degrees Celsius, water flow, and total dissolved solid content in the water. In general, increasing the number of leach tanks to ensure effective leaching out of unwanted water-soluble materials.

Pre Polymer/Dry Oven

After pre-leach the leached film could be dried partially to enable optional polymer coating and beading.

If the film to be coated with polymer, it is preferable to dry up the film to enable proper coating of polymer. The concentration of the polymer could be 1% to 4% depending on the type of polymer and the intended donning characteristics. The polymer could be of various but restricted to polyacrylic, polyacrylate, polyurethane or mixtures thereof.

Beading

Beading is done to provide ease of handling while wearing the glove by the end user. For proper un-distorted beading the film condition is important which are controlled by the gelling ovens and water level at pre-leaching. The control parameter is the bead roller or brush condition, the material of beading roller or brush, the length of beading roller—longer the roller the bead will be uniform. The beading thickness is the resultant quality characteristics.

Vulcanization

The elastomeric film undergoes vulcanization in a series of ovens with varying temperature profile starting from 60 degrees Celsius up to as high as 140 degrees Celsius to enable gradual release of moisture and effective cross linking.

The vulcanization oven is split into various segments to enable separate control over each segment. The compartmentalization enables slow release of moisture from the partially wet film. Once the film is fully dry, the vulcanization process begins.

Vulcanization is the process by which the cross linking of the individual polymer strands occurs by both ionic cross linking and covalent crosslinking mechanism. The ionic crosslinking is enabled by the polyvalent metallic oxides and polyvalent metallic hydroxides. In retrospect, covalent crosslinking is enabled by the sulphur and sulphur donors called accelerators.

When the formers pass through the hot air circulated ovens, the film loses its residual moisture for the most important process called crosslinking and retain the shape of the former. Even though crosslinking takes place in the maturation tank in the compounding and the dip tanks, those crosslinking is at low level and arbitrary and does not form a shape or not allowed to form a shape by constant stirring or circulating. In the unfavourable condition it may form a localized lump or coagulation of arbitrary shape. In the vulcanization the cross linking is orchestrated in such a way to take the shape of the former. In the condensation reaction called ionic bonding, water is released and that water is removed by the hot air circulating through the space near the film without removal of the water the reaction could be incomplete or reversible. For the covalent bonding lot of energy is required which is supplied by the hot air circulating throughout the oven the chain passes through.

Fundamentally the temperature and the residence time of the material to be vulcanized determines the crosslinking density, in turn the strength of the film. Higher temperatures and longer residence time translate to higher tensile strength of the film. The addition of accelerator act as a catalyst for the reaction to enable the bonding at lower temperature and lower time. The rotation of the former ensures the uniform heating of the film throughout its journey through the oven.

Chlorination

The vulcanized film could be optionally cooled and chlorinated and neutralized and post leached.

After vulcanization, if the donning surface must be chlorinated, the former with the formed glove is passed to through a series of cooling tanks to bring down the former temperature near about ambient or more preferably below 35 degrees Celsius. The cooled former then passed through the chlorine water tanks either a single or double tank depending on the residence time between 30 secs to 60 secs. The chlorine bath is maintained at lower temperature to minimize the evaporation of the chlorine.

Chlorination is the process whereby the unreacted double bonds of the inner surface are broken up and chlorine attached to the same, in the absence of the unsaturated double bonds the tackiness of the donning side film is removed. The chlorine level varies from 300 to 1200 ppm for the sensitive thin films, wherein the chlorine level could be reduced to even 100 ppm level. For thicker products, the chlorine level could be increased since the film rupture will be insignificant.

After chlorination, the film will be neutralized using mild alkali or fresh water. This enables the removal of excess chlorine or residual chlorine left out after the chlorination process.

The removal of the residual chlorine is important because residual chlorine affects the elastomeric film properties, shelf life and possibly product colour change.

Post Leaching

After neutralization, the elastomeric film is further leached out in a series of tanks at temperature of 30-95 degrees Celsius to leach out any residual chemicals.

The leached film could be optionally coated with donning aids either silicone solution, non-silicone based polymeric material or cationic surfactants. The elastomeric film then pass through oven called slurry oven. The temperature condition is same as the other drying ovens.

The dried film then be stripped off either manually or mechanically using auto stripping machine. It is preferable to have moisture content after stripping less than 1.0% or preferably less than 0.5%. Excess residual moisture may lead to a sticky end-product.

Packing

The stripped glove could be packed directly or packed after post processing called tumbling. For special application like clean room, the stripped glove could be further processed off line with subsequent washing, surface treating and dried up with the moisture content of less than 1%.

### EXAMPLES

A total of 110 experiments was completed to demonstrate the flexibility associated with the present invention as well as elastomeric film application pertaining to specific needs.

The testing was done against ASTM where Tensile Strength (TS), Modulus at 300% and 500% (M300, M500) are measured in MPa. The elongation is measured in percentage, as a ratio compared to the original length before elongation and the length at break. Test was done as per the guidelines of ASTM D 412. The reference standard for property is ASTM D 6319.

Material Particulars

| Code | Name |
|---|---|
| Surfactant 1 | SDBS-Sodium Dodecyl Benzene Sulfonate |
| Surfactant 2 | SLES-Sodium Lauryl Ether Sulfate |
| KOH | Potassium Hydroxide |
| NH₄OH | Ammonium Hydroxide |
| AO | Anitoxidant - Lowinox CPL |
| SDVMH | Soluble Divalent metal hydroxide - Al(OH)₃ |
| STVMH | Soluble trivalent metal hydroxide - Al(OH)₃ |
| DPTU | Diphenylthiourea |
| DPTT | DiPentamethylene Thiuram Tetra sulfide |
| PCP | Polychloroprene |
| PCP-HG | Polychloroprene High Gel content |

| Code | Name |
|---|---|
| Nitrile 1 | High Acrylo Nitrile Content |
| Nitrile 2 | Medium Acrylo Nitrile Content |
| Nitrile 3 | High-Medium Acrylo Nitrile Content |
| NR | Natural Rubber |
| IR | Isoprene Rubber (Synthetic) |
| CaCO₃ | Calcium Carbonate |
| TiO₂ | Titanium dioxide |
| ZDBC | Zinc dibutyl dithiocarbomate |
| DPG | Diphenyl Guinidine |

The term phr is commonly used in the preparation of rubber compound which means parts per hundred parts of rubber.

| | Exp 1 | Exp 2 | Exp 3 | Exp 4 | Exp 5 | Exp 6 | Exp 7 | Exp 8 | Exp 9 | Exp 10 | Exp 11 | Exp 12 | Exp 13 | Exp 14 | Exp 15 |
|---|---|---|---|---|---|---|---|---|---|---|---|---|---|---|---|
| Ni- | 100 | 100 | 100 | 100 | 100 | 100 | 100 | | | | | | | | |
| trile 1 | | | | | | | | | | | | | | | |
| Ni- | | | | | | | | 100 | 100 | 100 | 100 | 100 | 100 | 100 | 100 |
| trile 2 | | | | | | | | | | | | | | | |
| PCP | 0 | 0 | 0 | 0 | 10 | 10 | 10 | | | | | | | | |
| ZnO | 0.4 | 0.4 | 0.4 | 0.3 | 0.3 | 0.3 | 0.3 | 0.3 | 0.25 | 0.25 | 0.25 | 0.25 | 0.25 | 0.25 | 0.25 |
| STV- | 0.05 | 0.15 | 0.25 | 0.3 | 0.3 | 0.5 | 1 | 0.4 | 0.25 | 0.25 | 0.25 | 0.25 | 0.25 | 0.25 | 0.25 |
| MH | | | | | | | | | | | | | | | |
| Sulfur | 0.15 | 0.15 | 0.15 | 0.15 | 0.15 | 0.15 | 0.15 | 0.25 | 0.25 | 0.25 | 0.25 | 0.25 | 0.25 | 0.25 | 0.25 |
| ZD- | 0.05 | 0.05 | 0.05 | 0.05 | 0.05 | 0.05 | 0.05 | 0.05 | 0.05 | 0.1 | 0.1 | 0.1 | 0.1 | 0.1 | 0.1 |
| BC | | | | | | | | | | | | | | | |
| AO | 0.05 | 0.05 | 0.05 | 0.05 | 0.05 | 0.05 | 0.05 | 0.05 | 0.05 | 0.1 | 0.1 | 0.1 | 0.1 | 0.1 | 0.1 |
| TiO₂ | 0.33 | 0.33 | 0.33 | 0.33 | 1.33 | 1.33 | 1.33 | 0.5 | 0.5 | 0.5 | 0.5 | 0.5 | 0.5 | 0.5 | 0.5 |
| Sur- | 0.1 | 0.1 | 0.1 | 0.2 | 0.2 | 0.2 | 0.2 | 0.2 | 0.2 | 0.2 | 0.2 | 0.2 | 0.2 | 0.2 | 0.2 |
| fac- | | | | | | | | | | | | | | | |
| tant 1 | | | | | | | | | | | | | | | |
| Sur- | 0 | 0 | 0 | 0 | 0.1 | 0.1 | 0.1 | 0 | 0.2 | 0.2 | 0.2 | 0.2 | 0.2 | 0.2 | 0.2 |
| fac- | | | | | | | | | | | | | | | |
| tant 2 | | | | | | | | | | | | | | | |
| Ben- | 0.33 | 0.33 | 0.33 | 0.33 | 0.33 | 0.33 | 0.33 | 0.33 | 0.41 | 0.41 | 0.41 | 0.41 | 0.41 | 0.41 | 0.41 |
| ton- | | | | | | | | | | | | | | | |
| ite | | | | | | | | | | | | | | | |
| NH₄- | 0.05 | 0.05 | 0.05 | 0.05 | 0.05 | 0.05 | 0.05 | 0.08 | 0.08 | 0.08 | 0.08 | 0.08 | 0.08 | 0.08 | 0.08 |
| OH | | | | | | | | | | | | | | | |
| KOH | 1.5 | 1.5 | 1.5 | 1.5 | 1.5 | 1.5 | 1.5 | 1.5 | 1.75 | 1.75 | 1.75 | 1.75 | 1.75 | 1.75 | 1.75 |
| Ca- | 15 | 15 | 15 | 45 | 45 | 45 | 45 | 50 | 60 | 40 | 30 | 20 | 40 | 30 | 20 |
| CO₃ | | | | | | | | | | | | | | | |
| Starch | | | | | | | | | | | | | 6 | 3 | 1 |

| | Exp 16 | Exp 17 | Exp 18 | Exp 19 | Exp 20 | Exp 21 | Exp 22 | Exp 23 | Exp 24 |
|---|---|---|---|---|---|---|---|---|---|
| Nitrile 2 | 100 | 100 | 100 | 10 | 100 | 100 | 100 | 100 | 10 |
| PCP | | | | 100 | | | | | 100 |
| ZnO | 0.25 | 0.25 | 0.25 | 6 | 0.25 | 0.25 | 0.25 | 0.25 | 5 |
| STVMH | 0.15 | 0.15 | 0.25 | 0.25 | 0.4 | 0.4 | 0.4 | 0.4 | 0 |
| Sulfur | 0.25 | 0.25 | 0.25 | 0.5 | 0.15 | 0.15 | 0.15 | 0.15 | 1 |
| ZDBC | 0.15 | 0.15 | 0.15 | 0.5 | 0.05 | 0.05 | 0.05 | 0.05 | 0.5 |
| DPTU | | | | | | | | | 1.25 |
| DPG | | | | | | | | | 1.25 |
| AO | 0.15 | 0.15 | 0.15 | 2 | 0.15 | 0.15 | 0.15 | 0.15 | 2 |
| TiO2 | 1 | 1 | 1 | 1 | 2.2 | 2.2 | 2.2 | 2.2 | 1 |
| Surfactant 1 | 0.2 | 0.2 | 0.2 | 0 | 0 | 0 | 0 | 0 | 0 |
| Surfactant 2 | 0 | 0 | 0 | 0.5 | 0 | 0 | 0 | 0 | 0.3 |
| Bentonite | 0.33 | 0.33 | 0.33 | 0.33 | 0.33 | 0.33 | 0.33 | 0.33 | 0.33 |
| NH₄OH | 0.1 | 0.1 | 0.1 | 0.08 | 0.1 | 0.1 | 0.1 | 0.1 | 0.1 |
| KOH | 2 | 2 | 2 | 1 | 1.5 | 1.5 | 1.5 | 1.5 | 0.5 |
| CaCO₃ | 10 | 10 | 20 | 50 | 0 | 10 | 20 | 30 | 30 |
| Clay | 10 | 20 | 20 | | 0 | 0 | 0 | 0 | |
| Starch | | | 0.5 | | 0.5 | 0.5 | 0.5 | 0.5 | |
| | | Exp 25 | Exp 26 | Exp 27 | Exp 28 | Exp 29 | Exp 30 | Exp 31 | Exp 32 |
| | Nitrile 2 | 100 | 100 | 100 | 100 | 100 | 100 | 100 | 90 |
| | PCP | | | | | | | | 10 |
| | ZnO | 0.5 | 0.5 | 0.05 | 0.05 | 0.05 | 0.05 | 0.05 | 0 |
| | STVMH | 0.4 | 0.4 | 0.25 | 0.25 | 0.25 | 0.35 | 0.4 | 0.25 |
| | Sulfur | 0.2 | 0.2 | 0.2 | 0.2 | 0.2 | 0.3 | 0.35 | 0.25 |
| | ZDBC | 0.05 | 0.05 | 0.05 | 0.05 | 0.05 | 0.05 | 0.05 | 0.05 |
| | DPTU | 0.2 | 0.2 | | | | | | 0.05 |
| | DPG | 0.2 | 0.2 | | | | | | |
| | AO | 0.4 | 0.4 | 0.2 | 0.2 | 0.2 | 0.2 | 0.2 | 0.25 |
| | TiO2 | 1 | 1 | 2 | 2 | 2 | 2 | 2 | 1 |
| | Surfactant 1 | 0 | 0 | 0 | 0 | 0 | 0 | 0 | 0.2 |
| | Surfactant 2 | 0 | 0 | 0 | 0 | 0 | 0 | 0 | 0 |
| | Bentonite | 0.33 | 0.33 | 0.33 | 0.33 | 0.33 | 0.33 | 0.33 | 0.33 |
| | NH₄OH | 0.1 | 0.1 | 0.1 | 0.1 | 0.1 | 0.1 | 0.1 | 0.1 |
| | KOH | 1.7 | 1.7 | 1.7 | 1.7 | 1.7 | 1.7 | 1.7 | 1.7 |
| | CaCO₃ | 0 | 20 | 0 | 0 | 0 | 0 | 0 | 30 |
| | Clay | 0 | 0 | 10 | 20 | 30 | 40 | 50 | 30 |
| | Starch | 0.5 | 0.5 | 0.5 | 0.5 | 0.5 | 0.5 | 0.5 | 0.5 |

| | Exp | Exp | Exp | Exp | Exp | Exp | Exp | Exp | Exp | Exp | Exp | Exp | Exp | Exp | Exp | Exp | Exp |
|---|---|---|---|---|---|---|---|---|---|---|---|---|---|---|---|---|---|
| | 33 | 34 | 35 | 36 | 37 | 38 | 39 | 40 | 41 | 42 | 43 | 44 | 45 | 46 | 47 | 48 | 49 |
| Nitrile 1 | | | | | | 100 | 100 | 100 | 100 | 100 | 100 | 100 | 100 | 100 | 100 | 100 | 100 |
| Nitrile 2 | 90 | 90 | 80 | 80 | 60 | | | | | | | | | | | | |
| PCP | 10 | 10 | | | | | | | | | | | | | | | |
| IR | 10 | 10 | | | | | | | | | | | | | | | |
| NR | | | 20 | 20 | 40 | | | | | | | | | | | | |
| ZnO | 0 | 0 | 0.1 | 0.45 | | 1.2 | 1.2 | 1.2 | 1.2 | 1.2 | 1.2 | 1.2 | 1.2 | 1.2 | | | |
| SDVMH | | | | | | | | | | | | | | | 0.0025 | 0.002 | 0.0025 |
| STVMH | 0.25 | 0.25 | 0.15 | 0.15 | 0.15 | | | | | | | | | | | | |
| Sulfur | 0.45 | 0.75 | 0.3 | 0.6 | 0.5 | 1 | 1 | 1 | 1 | 1 | 1 | 1 | 1 | 1 | | | |
| ZDBC | 0.35 | 0.35 | 0.15 | 0.15 | 0.2 | 1 | 1 | 1 | 1 | 1 | 1 | 1 | 1 | 1 | | | |
| DPTU | 0.05 | 0.05 | 0 | 0 | 0 | | | | | | | | | | | | |
| DPTT | | 0.2 | | 0.2 | 0.2 | | | | | | | | | | | | |
| AO | 0.25 | 0.25 | 0.2 | 0.2 | 0.2 | 0.4 | 0.4 | 0.4 | 0.4 | 0.4 | 0.4 | 0.4 | 0.4 | 0.4 | 0.2 | 0.2 | 0.2 |
| TiO2 | 1 | 1 | 1 | 1 | 2 | 2 | 2 | 2 | 2 | 2 | 2 | 2 | 2 | 2 | 2.5 | 2.5 | 2.5 |
| Surfactant | 0.2 | 0.2 | 0 | 0 | 0.2 | 0.2 | 0.2 | 0.2 | 0.2 | 0.2 | 0.2 | 0.2 | 0.2 | 0.2 | 0.2 | 0.2 | 0.2 |
| 1 | | | | | | | | | | | | | | | | | |
| Surfactant | 0 | 0 | 0.2 | 0.2 | 0 | | | | | | | | | | | | |
| 2 | | | | | | | | | | | | | | | | | |
| Bentonite | 0.33 | 0.33 | 0.33 | 0.33 | | | | | | | | | | | | | |
| NH₄OH | 0.1 | 0.1 | 0.1 | 0.1 | 0.1 | | | | | | | | | | | | |
| KOH | 1.7 | 1.7 | 1.7 | 1.7 | 1.7 | 1.7 | 1.7 | 1.7 | 1.7 | 1.7 | 1.7 | 1.7 | 1.7 | 1.7 | 1.7 | 1.7 | 1.7 |
| CaCO₃ | 30 | 30 | 21 | 21 | 0 | 0 | 10 | 20 | 30 | 40 | 50 | 60 | 60 | 70 | | | 20 |
| Clay | 30 | 30 | 22 | 22 | 30 | 0 | 0 | 0 | 0 | 0 | | | | | | | |
| Starch | | | | | | | | | | | | | 2 | 2 | | | |

| | Exp | Exp | Exp | Exp | Exp | Exp | Exp | Exp | Exp |
|---|---|---|---|---|---|---|---|---|---|
| | 50 | 51 | 52 | 53 | 54 | 55 | 56 | 57 | 58 |
| Nitrile 1 | 100 | 100 | 100 | 100 | 100 | 100 | 100 | 100 | 100 |
| SDVMH | 0.002 | 0.0025 | 0.002 | 0.0025 | 0.002 | 0.0025 | 0.002 | 0.0015 | 0.001 |
| STVMH | | | | | | | | | |
| AO | 0.2 | 0.2 | 0.2 | 0.2 | 0.2 | 0.2 | 0.2 | 0.2 | 0.2 |
| TiO2 | 2.5 | 2.5 | 2.5 | 2.5 | 2.5 | 2.5 | 2.5 | 2.5 | 2.5 |
| Surfactant 1 | 0.2 | 0.2 | 0.2 | 0.2 | 0.2 | 0.2 | 0.2 | 0.4 | 0.4 |
| KOH | 1.7 | 1.7 | 1.7 | 1.7 | 1.7 | 1.7 | 1.7 | 1.7 | 1.7 |
| CaCO₃ | 20 | 36.5 | 36.5 | 56.5 | 56.5 | 76.5 | 76.5 | 0 | 0 |
| Starch | | 2 | 2 | 2 | 2 | 2 | 2 | 1 | 1 |
| | | Exp | Exp | Exp | Exp | Exp | Exp | Exp | Exp |
| | | 59 | 60 | 61 | 62 | 63 | 64 | 65 | 66 |
| | Nitrile 1 | 100 | 100 | 100 | 100 | 100 | 100 | 100 | 100 |
| | SDVMH | 0.0015 | 0.001 | 0.0015 | 0.001 | 0.0005 | 0.0005 | 0.0015 | 0.001 |
| | STVMH | | | | | | 0.0015 | | |
| | AO | 0.2 | 0.2 | 0.2 | 0.2 | 0.2 | 0.2 | 0.2 | 0.2 |
| | TiO2 | 2.5 | 2.5 | 2.5 | 2.5 | 2.5 | 2.5 | 2.5 | 2.5 |
| | Surfactant 1 | 0.4 | 0.4 | 0.4 | 0.4 | 0.4 | 0.4 | 0.4 | 0.4 |
| | KOH | 1.7 | 1.7 | 1.7 | 1.7 | 1.7 | 1.7 | 1.7 | 1.7 |
| | CaCO₃ | 20 | 20 | 40 | 40 | | | 60 | 60 |
| | Starch | 1 | 1 | 1 | 1 | | | 1 | 1 |

| | Exp | Exp | Exp | Exp | Exp | Exp | Exp | Exp | Exp |
|---|---|---|---|---|---|---|---|---|---|
| | 67 | 68 | 69 | 70 | 71 | 72 | 73 | 74 | 75 |
| Nitrile 1 | 100 | 100 | 100 | 100 | 100 | 80 | | | 75 |
| Nitrile 2 | | | | | | | 100 | 100 | |
| PCP | | | | | | | | | |
| PCP-HG | | | | | | 20 | | | 25 |
| SDVMH | 0.0005 | 0.0015 | 0.001 | 0.0005 | 0.0005 | 0.01 | | | 0.0025 |
| ZnO | | | | | | | 0.25 | 0.25 | |
| STVMH | 0.0015 | | | 0.05 | 0.05 | | 0.4 | 0.1 | |
| Sulfur | | | | | | | | | |
| ZDBC | | | | | | | 0.05 | 0.05 | |
| DPTU | | | | | | | | | |
| DPTT | | | | | | | | | |
| NaMBT | | | | | | | | | |
| AO | 0.2 | 0.2 | 0.2 | 0.2 | 0.2 | 0.2 | 0.15 | 0.15 | 0.2 |
| TiO2 | 2.5 | 2.5 | 2.5 | 2.5 | 2.5 | 2.5 | 0.5 | 2 | 2.5 |
| Surfactant 1 | 0.4 | 0.4 | 0.4 | 0.4 | 0.4 | 0.4 | | | 0.4 |
| Surfactant 2 | | | | | | | | | 0.1 |
| KOH | 1.7 | 1.7 | 1.7 | 1.7 | 1.7 | 1.7 | 1.7 | 1.7 | 1.7 |
| CaCO₃ | | 80 | 80 | | 50 | | 20 | 20 | |
| Clay | | | | | | | | | |
| Starch | | 1 | 1 | | | | | | |
| | | Exp | Exp | Exp | Exp | Exp | Exp | Exp | Exp |
| | | 76 | 77 | 78 | 79 | 80 | 81 | 82 | 83 |
| | Nitrile 1 | | | | | | 14.5 | | 20 |
| | Nitrile 2 | | 100 | | | 100 | | 100 | |
| | PCP | | | | | | | | 80 |
| | PCP-HG | 100 | | 100 | 100 | | 100 | | |
| | SDVMH | 0.02 | | 0.03 | 0.05 | | 0.05 | 0.25 | 0.03 |
| | ZnO | | 0.25 | | | 0.25 | | | 2 |
| | STVMH | | 0.1 | | | 0.2 | | 0.3 | 0.15 |
| | Sulfur | | 0.1 | | | 0.1 | | 0.1 | 0.5 |
| | ZDBC | | 0.05 | | | 0.05 | | 0.05 | |
| | DPTU | | | | | | | | 0.2 |
| | DPTT | | 0.2 | | | 0.2 | | 0.2 | 0.3 |
| | NaMBT | | | | | | | | 0.5 |
| | AO | 1.5 | 0.15 | 1.5 | 1.5 | 0.15 | 1.5 | 0.15 | 1 |
| | TiO2 | 2 | 2 | 2 | 2 | 2 | 2 | 2 | 2 |
| | Surfactant 1 | | | | | | | | 0.2 |
| | Surfactant 2 | 0.75 | | 0.75 | 0.75 | | 0.75 | | 0.3 |
| | KOH | 1 | 1.7 | 1 | 1 | 1.7 | 1 | 1.7 | 1.5 |
| | CaCO₃ | 10 | 20 | 10 | 10 | 20 | 10 | 20 | 40 |
| | Clay | 10 | | 10 | 10 | | 10 | | |
| | Starch | | | | | | | | 1 |

| | Exp | Exp | Exp | Exp | Exp | Exp | Exp | Exp | Exp | Exp | Exp | Exp | Exp | Exp | Exp | Exp | Exp |
|---|---|---|---|---|---|---|---|---|---|---|---|---|---|---|---|---|---|
| | 84 | 85 | 86 | 87 | 88 | 89 | 90 | 91 | 92 | 93 | 94 | 95 | 96 | 97 | 98 | 99 | 100 |
| Nitrile 1 | 100 | 100 | | | | 20 | | | | | 70 | 70 | 100 | 100 | | | |
| Nitrile 2 | | | 100 | 100 | | | | 100 | | 100 | | | | | 100 | 100 | 100 |
| Nantex | | | | | 100 | | 100 | | 100 | | | | | | | | |
| PCP | | | | | | 80 | | | | | 10 | 10 | | | | | |
| PCP-HG | 10 | 10 | | | | | | | | | | | | | | | |
| NR | 10 | 10 | | 10 | 20 | | 20 | 10 | 20 | 10 | 20 | 20 | | | | | |
| SDVMH | | 0.01 | 0.02 | 0.02 | 0.02 | 0.03 | 0.02 | 0.02 | 0.02 | 0.02 | 0.02 | 0.02 | 0.04 | 0.04 | | | |
| ZnO | | | | | | 4 | | | | | | 2 | | | 0.25 | 0.25 | 0.25 |
| STVMH | 0.2 | 0.2 | 0.15 | 0.15 | 0.2 | 0.15 | 0.3 | 0.15 | 0.3 | 0.15 | 0.15 | 0.15 | 0.15 | 0.15 | 0.2 | 0.3 | 0.4 |
| Sulfur | 0.2 | 0.2 | 0.2 | 0.4 | 0.25 | 0.5 | 0.25 | 0.4 | 0.25 | 0.4 | 0.4 | 0.4 | 0.4 | 0.4 | 0.2 | 0.2 | 0.2 |
| ZDBC | | | | 0.2 | | | | 0.2 | | 0.2 | 0.2 | 0.2 | 0.2 | 0.2 | 0.05 | 0.05 | 0.05 |
| DPTU | | | | | | 0.2 | | | | | | | | | | | |
| DPTT | 0.1 | 0.1 | 0.2 | 0.2 | 0.2 | 0.3 | 0.2 | 0.2 | 0.2 | 0.2 | 0.2 | 0.2 | 0.2 | 0.2 | | | |
| NaMBT | | | | | 0.2 | 0.5 | 0.2 | | 0.2 | | | | | | | | |
| AN | 0.4 | 0.4 | 0.4 | 0.4 | 0.4 | 1 | 0.4 | 0.4 | 0.4 | 0.4 | 0.4 | 0.4 | 0.4 | 0.4 | 0.15 | 0.15 | 0.15 |
| TiO2 | 2 | 2 | 2 | 2 | 2 | 2 | 2 | 2 | 2 | 2 | 2 | 2 | 2 | 2 | 2.5 | 2.5 | 2.5 |
| Surfactant | 0.5 | 0.5 | 0.2 | 0.2 | 0.4 | 0.2 | 0.4 | 0.2 | 0.4 | 0.2 | 0.2 | 0.2 | 0.2 | 0.2 | 0.2 | 0.2 | 0.2 |
| 1 | | | | | | | | | | | | | | | | | |
| Surfactant | 0.25 | 0.25 | 0.2 | 0.2 | 0.1 | 0.3 | 0.1 | 0.2 | 0.1 | 0.2 | 0.2 | 0.2 | 0.2 | 0.2 | | | |
| 2 | | | | | | | | | | | | | | | | | |
| Bentonite | | | | | | | | | | | | | | | 0.4 | 0.4 | 0.4 |
| NH₄OH | | | | | | | | | | | | | | | 0.1 | 0.1 | 0.1 |
| KOH | 1.5 | 1.5 | 1.5 | 1.5 | | 1.5 | | 1.5 | 1.7 | 1.5 | 1.5 | 1.5 | 1.5 | 1.5 | 1.7 | 1.7 | 1.7 |
| CaCO₃ | 40 | 60 | 30 | 50 | 80 | 40 | 100 | 70 | 120 | 90 | 40 | 40 | | 80 | 20 | 20 | 20 |
| Starch | | | 1 | 1 | | 1 | | 1 | | | | | 1 | 1 | | | |

| | Exp | Exp | Exp | Exp | Exp | Exp | Exp | Exp | Exp | Exp |
|---|---|---|---|---|---|---|---|---|---|---|
| | 101 | 102 | 103 | 104 | 105 | 106 | 107 | 108 | 109 | 110 |
| Nitrile 1 | | | | | | | | | 100 | 100 |
| Nitrile 2 | 100 | 100 | 100 | 100 | 100 | 100 | 100 | 100 | | |
| SDVMH | | | | | | 0.002 | 0.004 | 0.004 | | |
| ZnO | 0.25 | 0.25 | 0.25 | 0.25 | 0.25 | | | | 0.4 | 0.4 |
| STVMH | 0.5 | 0.3 | 0.4 | 0.2 | 0.2 | | | 0.2 | 0.15 | 0.25 |
| Sulfur | 0.2 | 0.2 | 0.2 | 0.2 | 0.2 | 0.05 | 0.05 | 0.05 | 0.15 | 0.15 |
| ZDBC | 0.05 | 0.05 | 0.05 | 0.05 | 0.05 | 0.05 | 0.05 | 0.05 | 0.05 | 0.05 |
| AO | 0.15 | 0.15 | 0.15 | 0.15 | 0.15 | 0.15 | 0.15 | 0.15 | 0.05 | 0.05 |
| TiO2 | 2.5 | 2.5 | 2.5 | 2.5 | 2.5 | 2.5 | 2.5 | 2.5 | 0.33 | 0.33 |
| Surfactant | 0.2 | 0.2 | 0.2 | 0.2 | 0.2 | 0.2 | 0.2 | 0.2 | 0.1 | 0.1 |
| 1 | | | | | | | | | | |
| Bentonite | 0.4 | 0.4 | 0.4 | 0.4 | 0.4 | | | | 0.33 | 0.33 |
| NH₄OH | 0.1 | 0.1 | 0.1 | 0.1 | 0.1 | | | | 0.05 | 0.05 |
| KOH | 1.7 | 1.7 | 1.7 | 1.7 | 1.7 | 1.7 | 1.7 | 1.7 | 1.5 | 1.5 |
| CaCO₃ | 20 | 25 | 25 | 15 | 25 | 50 | 75 | 100 | 50 | 75 |
| Starch | | | | | | 1 | 1 | 1 | | |

There are 28 sets of examples with various experimental data presented as examples described in further details for the present invention. The following examples are given to describe the invention in detail with reference to non-limiting embodiments.

### Example 1—Varying the Soluble Trivalent Metal Hydroxide with Constant Amount of Filler

| | Exp 1 | Exp 2 | Exp 3 |
|---|---|---|---|
| Nitrile 1 | 100 | 100 | 100 |
| ZnO | 0.4 | 0.4 | 0.4 |
| STVMH | 0.05 | 0.15 | 0.25 |
| Sulfur | 0.15 | 0.15 | 0.15 |
| ZDBC | 0.05 | 0.05 | 0.05 |
| AO | 0.05 | 0.05 | 0.05 |
| TiO2 | 0.33 | 0.33 | 0.33 |
| Surfactant 1 | 0.1 | 0.1 | 0.1 |
| Bentonite | 0.33 | 0.33 | 0.33 |
| NH₄OH | 0.05 | 0.05 | 0.05 |
| KOH | 1.5 | 1.5 | 1.5 |
| CaCO₃ | 15 | 15 | 15 |

| | | | | | After Aging at 100 | | | |
|---|---|---|---|---|---|---|---|---|
| | Before Aging | | | | degrees. C. / 22 hrs | | | |
| | TS | M300 | M500 | E % | TS | M300 | M500 | E % |
| Exp | 19.4 | 2.67 | 5.12 | 725 | 22.48 | 3.18 | 7.14 | 674 |
| 1 | | | | | | | | |
| Exp | 26.57 | 4.53 | 11.62 | 630 | 30.86 | 4.56 | 11.01 | 655 |
| 2 | | | | | | | | |
| Exp | 33.05 | 6.07 | 15.37 | 640 | 37.65 | 5.86 | 18.76 | 666 |
| 3 | | | | | | | | |

Based on data collected from experiment 1-3, filler amount is constant at 15 phr. With increasing soluble trivalent metal hydroxide, a proportional increase in tensile strength and in M500, however the elongation value is above 600% for both before and after aging.

### Example 2—Varying the Soluble Trivalent Metal Hydroxide with Constant Filler and Second Elastomer

| | Exp 4 | Exp 5 | Exp 6 | Exp 7 |
|---|---|---|---|---|
| Nitrile 1 | 100 | 100 | 100 | 100 |
| PCP | 0 | 10 | 10 | 10 |
| ZnO | 0.3 | 0.3 | 0.3 | 0.3 |
| STVMH | 0.3 | 0.3 | 0.5 | 1 |
| Sulfur | 0.15 | 0.15 | 0.15 | 0.15 |
| ZDBC | 0.05 | 0.05 | 0.05 | 0.05 |
| AO | 0.05 | 0.05 | 0.05 | 0.05 |
| TiO2 | 0.33 | 1.33 | 1.33 | 1.33 |
| Surfactant 1 | 0.2 | 0.2 | 0.2 | 0.2 |
| Surfactant 2 | 0 | 0.1 | 0.1 | 0.1 |
| Bentonite | 0.33 | 0.33 | 0.33 | 0.33 |
| NH₄OH | 0.05 | 0.05 | 0.05 | 0.05 |
| KOH | 1.5 | 1.5 | 1.5 | 1.5 |
| CaCO₃ | 45 | 45 | 45 | 45 |

| | | | | | After Aging at 100 deg. C. / | | | |
|---|---|---|---|---|---|---|---|---|
| | Before Aging | | | | 22 hrs | | | |
| | TS | M300 | M500 | E % | TS | M300 | M500 | E % |
| Exp 4 | 17.31 | 4.42 | 8.17 | 664 | 18.82 | 5.14 | 9.9 | 624 |
| Exp 5 | 18.9 | 5.35 | 10.36 | 618 | 19.98 | 5.51 | 10.79 | 614 |
| Exp 6 | 16.54 | 4.86 | 9.83 | 611 | 19.56 | 4.81 | 9.36 | 663 |
| Exp 7 | 15.51 | 5.62 | 11.66 | 567 | 22 | 7.65 | 15.68 | 582 |

Based on data collected from experiment 4-7, the amount of filler load at 45 phr is considered high but still meets the ASTM D6319 requirements for tensile and elongation. Furthermore, elongation up to 0.5 level of soluble trivalent metal hydroxide exceeds the ASTM D 6319 standards requirement of above 600% against 500% in both before and after aging conditions.

### Example 3—Varying the Soluble Trivalent Metal Hydroxide with Variable High Amount of Filler

| | Exp 8 | Exp 9 |
|---|---|---|
| Nitrile 2 | 100 | 100 |
| ZnO | 0.3 | 0.25 |
| STVMH | 0.4 | 0.25 |
| Sulfur | 0.25 | 0.25 |
| ZDBC | 0.05 | 0.05 |
| AO | 0.05 | 0.05 |
| TiO2 | 0.5 | 0.5 |
| Surfactant 1 | 0.2 | 0.2 |
| Surfactant 2 | 0 | 0.2 |
| Bentonite | 0.33 | 0.41 |
| NH₄OH | 0.08 | 0.08 |
| KOH | 1.5 | 1.75 |
| CaCO₃ | 50 | 60 |

| | | | | | After Aging at 100 deg. C. / | | | |
|---|---|---|---|---|---|---|---|---|
| | Before Aging | | | | 22 hrs | | | |
| | TS | M300 | M500 | E % | TS | M300 | M500 | E % |
| Exp 8 | 20.01 | 7.2 | 14.96 | 560 | 24.56 | 9.12 | 19.72 | 544 |
| Exp 9 | 19.25 | 6.39 | 11.92 | 600 | 21.12 | 6.41 | 11.02 | 648 |

Based on the data collected from experiment 8 & 9, an increase in filler loading up to 50-60 phr. the gloves could be softer with reduced soluble trivalent metal hydroxide, but still meets the ASTM D 6319 requirements. The after aging result of 60 phr filler is almost similar to the before aging results, wherein improvement is seen with respect to softness and strength. The result also indicates an improved shelf life.

### Example 4—Constant Soluble Trivalent Metal Hydroxide with Variable Amount of Filler

| | EXP 10 | EXP 11 | EXP 12 |
|---|---|---|---|
| Nitrile 2 | 100 | 100 | 100 |
| ZnO | 0.25 | 0.25 | 0.25 |
| STVMH | 0.25 | 0.25 | 0.25 |
| Sulfur | 0.25 | 0.25 | 0.25 |
| ZDBC | 0.1 | 0.1 | 0.1 |
| AO | 0.1 | 0.1 | 0.1 |
| TiO2 | 0.5 | 0.5 | 0.5 |
| Surfactant 1 | 0.2 | 0.2 | 0.2 |
| Surfactant 2 | 0.2 | 0.2 | 0.2 |
| Bentonite | 0.41 | 0.41 | 0.41 |
| NH₄OH | 0.08 | 0.08 | 0.08 |
| KOH | 1.75 | 1.75 | 1.75 |
| CaCO₃ | 40 | 30 | 20 |

| | | | | | After Aging at 100 deg. C. / | | | |
|---|---|---|---|---|---|---|---|---|
| | Before Aging | | | | 22 hrs | | | |
| | TS | M300 | M500 | E % | TS | M300 | M500 | E % |
| EXP | 20.37 | 4.18 | 9.1 | 646 | 22.93 | 5.07 | 9.92 | 659 |
| 10 | | | | | | | | |
| EXP | 23.41 | 5.34 | 12.37 | 606 | 25.17 | 4.7 | 9.76 | 669 |
| 11 | | | | | | | | |
| EXP | 19.56 | 4.24 | 10.12 | 609 | 27.06 | 5.54 | 13.92 | 606 |
| 12 | | | | | | | | |

Based on the data collected from experiment 10-12, after aging result indicate tensile strength drops with increasing filler phr. However, M500 and elongation displayed contradicting results. It is the intention of the present invention to use higher filler phr as the synthetic latex composition requirements.

### Example 5—Constant Soluble Trivalent Metal Hydroxide with Variable Amount of Filler and Variable Amount of Biodegradable Material

| | Exp 13 | Exp 14 | Exp 15 |
|---|---|---|---|
| Nitrile 2 | 100 | 100 | 100 |
| ZnO | 0.25 | 0.25 | 0.25 |
| STVMH | 0.25 | 0.25 | 0.25 |
| Sulfur | 0.25 | 0.25 | 0.25 |
| ZDBC | 0.1 | 0.1 | 0.1 |
| AO | 0.1 | 0.1 | 0.1 |
| TiO2 | 0.5 | 0.5 | 0.5 |
| Surfactant 1 | 0.2 | 0.2 | 0.2 |
| Surfactant 2 | 0.2 | 0.2 | 0.2 |
| Bentonite | 0.41 | 0.41 | 0.41 |
| NH₄OH | 0.08 | 0.08 | 0.08 |
| KOH | 1.75 | 1.75 | 1.75 |
| CaCO₃ | 40 | 30 | 20 |
| Starch | 6 | 3 | 1 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 13 | 18 | 4.31 | 8.62 | 657 | 21.11 | 5.24 | 10.89 | 673 |
| Exp 14 | 20.79 | 4.98 | 10.89 | 619 | 20.99 | 4.58 | 8.41 | 667 |
| Exp 15 | 22.51 | 4.77 | 11.31 | 620 | 26.94 | 4.7 | 11.5 | 680 |

Similar to Example 4, with the exception that biodegradable material is added into the composition. Based on the data collected for experiment 13-15, elongation is good and tensile is nominal, high tensile strength is observed with low amounts of fillers.

### Example 6—Constant Soluble Trivalent Metal Hydroxide with Variable Amount of Multiple Filler Combination

| | EXP 16 | EXP 17 |
|---|---|---|
| Nitrile 2 | 100 | 100 |
| ZnO | 0.25 | 0.25 |
| STVMH | 0.15 | 0.15 |
| Sulfur | 0.25 | 0.25 |
| ZDBC | 0.15 | 0.15 |
| AO | 0.15 | 0.15 |
| TiO2 | 1 | 1 |
| Surfactant 1 | 0.2 | 0.2 |
| Bentonite | 0.33 | 0.33 |
| NH₄OH | 0.1 | 0.1 |
| KOH | 2 | 2 |
| CaCO₃ | 10 | 10 |
| Clay | 10 | 20 |
| Starch | | |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| EXP 16 | 21.03 | 3.94 | 8.67 | 640 | 26.14 | 4.34 | 10.32 | 647 |
| EXP 17 | 24.65 | 4.87 | 10.4 | 652 | 27.43 | 6.26 | 15.02 | 604 |

Based on the data collected from experiment 16-17, increased level of multiple fillers starting from the total of 20 & 30 phr to 30 phr of total filler comprising l0 phr calcium carbonate and 20 phr clay shows better tensile values and elongation.

### Example 7—Combination of Solid and Soluble Trivalent Metal Hydroxide and Multiple Filler and Biodegrading Agent

| | EXP 18 |
|---|---|
| Nitrile 2 | 100 |
| ZnO | 0.25 |
| STVMH | 0.25 |
| Sulfur | 0.25 |
| ZDBC | 0.15 |
| AO | 0.15 |
| TiO2 | 1 |
| Surfactant 1 | 0.2 |
| Bentonite | 0.33 |
| NH₄OH | 0.1 |
| KOH | 2 |
| CaCO₃ | 20 |
| Clay | 20 |
| Starch | 0.5 |

| | Before Aging | | | | After Aging at 100 deg. C./22 hrs | | | |
|---|---|---|---|---|---|---|---|---|
| | TS | M300 | M500 | E % | TS | M300 | M500 | E % |
| EXP 18 | 21.03 | 7.77 | 18.11 | 530 | 20.34 | 6.02 | 13.54 | 582 |

Experiment 18 has increased level of multiple filler at 20 phr calcium carbonate and 20 phr silicious clay with the total of 40 phr and 0.5 phr of biodegradable starch. The film is harder and elongation is lower. However, ASTM D6319 requirements were met plus after aging elongation is performed better at 582% compared with ASTM D6319 requirement of 400% minimum. The tensile strength recorded above 20 MPa in both unaged and aged condition.

### Example 8—Multiple Latexes and Combination of Solid and Soluble Trivalent Metal Hydroxide and High Filler

| | Exp 19 |
|---|---|
| Nitrile 2 | 10 |
| PCP | 100 |
| ZnO | 6 |
| STVMH | 0.25 |
| Sulfur | 0.5 |
| ZDBC | 0.5 |
| AO | 2 |
| TiO2 | 1 |
| Surfactant 2 | 0.5 |
| Bentonite | 0.33 |
| NH₄OH | 0.08 |
| KOH | 1 |
| CaCO₃ | 50 |

| | Before Aging | | | | After Aging at 100 deg. C./22 hrs | | | |
|---|---|---|---|---|---|---|---|---|
| | TS | M300 | M500 | E % | TS | M300 | M500 | E % |
| EXP 19 | 10.06 | 3.08 | 6.16 | 670 | 12.66 | 4.91 | 10.09 | 580 |

Based on the data collected from experiment 19, low level of carboxylated nitrile component and high filler of 50 phr cause low physical values such as tensile strength and below ASTM D6319 standards. However, the glove feels soft and comfortable due to high level of polychloroprene.

### Example 9—Constant Soluble Trivalent Metal Hydroxide with Variable Amount of Filler and Constant Amount of Biodegradable Material

| | Exp 20 | Exp 21 | Exp 22 | Exp 23 |
|---|---|---|---|---|
| Nitrile 2 | 100 | 100 | 100 | 100 |
| ZnO | 0.25 | 0.25 | 0.25 | 0.25 |
| STVMH | 0.4 | 0.4 | 0.4 | 0.4 |
| Sulfur | 0.15 | 0.15 | 0.15 | 0.15 |
| ZDBC | 0.05 | 0.05 | 0.05 | 0.05 |
| AO | 0.15 | 0.15 | 0.15 | 0.15 |
| TiO2 | 2.2 | 2.2 | 2.2 | 2.2 |
| Bentonite | 0.33 | 0.33 | 0.33 | 0.33 |
| NH₄OH | 0.1 | 0.1 | 0.1 | 0.1 |
| KOH | 1.5 | 1.5 | 1.5 | 1.5 |
| CaCO₃ | 0 | 10 | 20 | 30 |
| Starch | 0.5 | 0.5 | 0.5 | 0.5 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 20 | 32.87 | 5.34 | 14.31 | 632 | 36.53 | 6.56 | 21.79 | 587 |
| Exp 21 | 34.01 | 6.15 | 18.72 | 594 | 39.12 | 8.65 | 29.04 | 557 |
| Exp 22 | 22.01 | 5.25 | 12.8 | 589 | 31.7 | 6.99 | 18.09 | 600 |
| Exp 23 | 21.97 | 2.5 | 11.15 | 625 | NA | NA | NA | NA |

In experiment 20-23, constant higher level of soluble trivalent metal hydroxide at 0.4 phr and varying filler starting from 0 to 30 phr was used. At 10 phr, the tensile values and modulus are high with elongation above 550% both in before and after aging.

### Example 10—Multiple Latexes and Solid Divalent Metal Oxide and Filler

| | Exp 24 |
|---|---|
| Nitrile 2 | 10 |
| PCP | 100 |
| ZnO | 5 |
| Sulfur | 1 |
| ZDBC | 0.5 |
| DPTU | 1.25 |
| DPG | 1.25 |
| AO | 2 |
| TiO2 | 1 |
| Surfactant 2 | 0.3 |
| Bentonite | 0.33 |
| NH₄OH | 0.1 |
| KOH | 0.5 |
| CaCO₃ | 30 |

| | Before Aging | | | | After Aging at 100 deg. C./22 hrs | | | |
|---|---|---|---|---|---|---|---|---|
| | TS | M300 | M500 | E % | TS | M300 | M500 | E % |
| Exp 24 | 11.87 | 1.9 | 3.73 | 876 | 18.1 | 3.24 | 7.62 | 722 |

Experiment 24 uses high polychloroprene and less amount of nitrile and filler of 30%. The after-aging results are good. The elongation and modulus in before aging are excellent thus indicating the softness and comfort specific to chloroprene material. Due to the addition of filler, the cost will come down. However, initial-unaged tensile is low indicating the improper curing.

### Example 11—Constant Soluble Trivalent Metal Hydroxide, Higher Amount of Insoluble Metal Oxide with Variable Amount of Filler and Constant Amount of Biodegradable Material

| | Exp 25 | Exp 26 |
|---|---|---|
| Nitrile 2 | 100 | 100 |
| ZnO | 0.5 | 0.5 |
| STVMH | 0.4 | 0.4 |
| Sulfur | 0.2 | 0.2 |
| ZDBC | 0.05 | 0.05 |
| DPTU | 0.2 | 0.2 |
| DPG | 0.2 | 0.2 |
| AO | 0.4 | 0.4 |
| TiO2 | 1 | 1 |
| Bentonite | 0.33 | 0.33 |
| NH₄OH | 0.1 | 0.1 |
| KOH | 1.7 | 1.7 |
| CaCO₃ | 0 | 20 |
| Clay | 0 | 0 |
| Starch | 0.5 | 0.5 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 25 | 21.57 | 6.37 | 14.2 | 580 | NA | NA | NA | NA |
| Exp 26 | 25.88 | 10 | 23.8 | 510 | 25.77 | 10.2 | 12.57 | 487 |

Based on the data collected from experiment 25 and 26, due to the presence of soluble polyvalent metal hydroxide the tensile properties are consistent in before aging and after aging conditions where the filler is added to the tune of 20 phr, the elongation just meets the ASTM D 6319 standard but the M500 drops in the aged condition. The high modulus and low elongation could be attributed to high level of curatives but still meet the borderline ASTM D 6319 standard requirement in the case of elastomeric property.

### Example 12—Varying Soluble Trivalent Metal Hydroxide, Low Amount of Insoluble Metal Oxide with Variable Amount of Filler and Constant Amount of Biodegradable Material

| | EXP 27 | EXP 28 | EXP 29 | EXP 30 | EXP 31 |
|---|---|---|---|---|---|
| Nitrile 2 | 100 | 100 | 100 | 100 | 100 |
| ZnO | 0.05 | 0.05 | 0.05 | 0.05 | 0.05 |
| STVMH | 0.25 | 0.25 | 0.25 | 0.35 | 0.4 |
| Sulfur | 0.2 | 0.2 | 0.2 | 0.3 | 0.35 |
| ZDBC | 0.05 | 0.05 | 0.05 | 0.05 | 0.05 |
| AO | 0.2 | 0.2 | 0.2 | 0.2 | 0.2 |
| TiO2 | 2 | 2 | 2 | 2 | 2 |
| Bentonite | 0.33 | 0.33 | 0.33 | 0.33 | 0.33 |
| NH₄OH | 0.1 | 0.1 | 0.1 | 0.1 | 0.1 |
| KOH | 1.7 | 1.7 | 1.7 | 1.7 | 1.7 |
| Clay | 10 | 20 | 30 | 40 | 50 |
| Starch | 0.5 | 0.5 | 0.5 | 0.5 | 0.5 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| EXP 27 | 29.5 | 4.02 | 10.7 | 650 | 43.49 | 7.4 | 20.2 | 614 |
| EXP 28 | 24.64 | 4.46 | 10.98 | 622 | 30.87 | 9.49 | 24.92 | 539 |
| EXP 29 | 21.95 | 4.96 | 12.58 | 595 | 28.09 | 10.17 | 24.62 | 524 |
| EXP 30 | 20.24 | 5.61 | 11.39 | 620 | 21.84 | 12.02 | NA | 453 |
| EXP 31 | 15.3 | 4.76 | 10.6 | 572 | 20.36 | 9.71 | 19.03 | 481 |

Based on the data collected from experiment 27, 28 & 29, all experimental data show common composition except the filler which gradually increases from 10, 20 to 30 phr. As the filler level increases the strength reduces and elongation reduces and modulus increases. However, the gloves still meet the ASTM D 6319 standard requirement.

With regards to data collected from experiment 30 & 31, the soluble trivalent metal hydroxide increases as well as the filler quantity. Data from experiment 31 shown properties that are barely conforming the ASTM D 6319 standard requirement indicating the limit of the curative and filler combinations.

In all the five cases, experiment 27 to 31, biodegradable material is added.

### Example 13—Multiple Latexes, Constant Trivalent Metal Hydroxide, Varying Sulphur Level and Constant Quantity of Multiple Type of Fillers

| | Exp 32 | Exp 33 | Exp 34 |
|---|---|---|---|
| Nitrile 2 | 90 | 90 | 90 |
| PCP | 10 | 10 | 10 |
| IR | 0 | 10 | 10 |
| STVMH | 0.25 | 0.25 | 0.25 |
| Sulfur | 0.25 | 0.45 | 0.75 |
| ZDBC | 0.05 | 0.35 | 0.35 |
| DPTU | 0.05 | 0.05 | 0.05 |
| DPTT | 0 | 0 | 0.2 |
| AO | 0.25 | 0.25 | 0.25 |
| TiO2 | 1 | 1 | 1 |
| Surfactant 1 | 0.2 | 0.2 | 0.2 |
| Bentonite | 0.33 | 0.33 | 0.33 |
| NH₄OH | 0.1 | 0.1 | 0.1 |
| KOH | 1.7 | 1.7 | 1.7 |
| CaCO₃ | 30 | 30 | 30 |
| Clay | 30 | 30 | 30 |
| Starch | 0.5 | 0 | 0 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 32 | 14.9 | 8.97 | NA | 468 | 16.24 | 11.16 | NA | 435 |
| Exp 33 | 12.13 | 5.33 | 10.11 | 542 | 12.46 | 5.62 | 10.8 | 528 |
| Exp 34 | 11.28 | 7.8 | NA | 445 | 12.26 | 7.62 | NA | 480 |

Based on the data collected from experiment 32-34, the filler quantity is constant at the higher tune of 60 parts. The latexes are multiple from 2 to 3. In the case of experiment 32, there are two latexes viz., nitrile and polychloroprene. Experiments 33 and 34 contains three combinations inclusive of synthetic isoprene. With regards to these experimental data, after aging test of experiment 32 passes the ASTM D 6319 standard requirement, however other results are above 11 MPa. The addition of IR lowers the physical properties but the glove feels softer relatively.

### Experiment 14—Multiple Latexes, Constant Soluble Trivalent Metal Hydroxide, Variable Solubilized Sulphur and Multiple Filler

| | Exp 35 | Exp 36 | Exp 37 |
|---|---|---|---|
| Nitrile 2 | 80 | 80 | 60 |
| NR | 20 | 20 | 40 |
| ZnO | 0.1 | 0.45 | 0 |
| STVMH | 0.15 | 0.15 | 0.15 |
| Sulfur | 0.3 | 0.6 | 0.5 |
| ZDBC | 0.15 | 0.15 | 0.2 |
| DPTT | 0 | 0.2 | 0.2 |
| AO | 0.2 | 0.2 | 0.2 |
| TiO2 | 1 | 1 | 2 |
| Surfactant 1 | 0 | 0 | 0.2 |
| Surfactant 2 | 0.2 | 0.2 | 0 |
| Bentonite | 0.33 | 0.33 | 0 |
| NH₄OH | 0.1 | 0.1 | 0.1 |
| KOH | 1.7 | 1.7 | 1.7 |
| CaCO₃ | 21 | 21 | 0 |
| Clay | 22 | 22 | 30 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 35 | 14.76 | 6.9 | 13.5 | 525 | 14.36 | 7.79 | NA | 480 |
| Exp 36 | 11.34 | 5.47 | 11.3 | 500 | 14.26 | 5.98 | 6.7 | 520 |
| Exp 37 | 9.99 | 4.49 | 8.65 | 533 | 10.48 | 5.1 | 8.9 | 600 |

Based on the data collected from experiment 35-37, the filler quantity varies from 30 to 43 parts against 100 parts total elastomer. Between experiment 35 and 36, the increase of sulphur, DPTT and zinc oxide does not make impact. The increased natural rubber reduces the strength of the glove considerably, however there is an increase in elongation.

### Example 15—Constant Solid Metal Oxide and Varying Filler Level

| | Exp 38 | Exp 39 | Exp 40 | Exp 41 | Exp 42 | Exp 43 | Exp 44 | Exp 45 | Exp 46 |
|---|---|---|---|---|---|---|---|---|---|
| Nitrile 1 | 100 | 100 | 100 | 100 | 100 | 100 | 100 | 100 | 100 |
| ZnO | 1.2 | 1.2 | 1.2 | 1.2 | 1.2 | 1.2 | 1.2 | 1.2 | 1.2 |
| Sulfur | 1 | 1 | 1 | 1 | 1 | 1 | 1 | 1 | 1 |
| ZDBC | 1 | 1 | 1 | 1 | 1 | 1 | 1 | 1 | 1 |
| AO | 0.4 | 0.4 | 0.4 | 0.4 | 0.4 | 0.4 | 0.4 | 0.4 | 0.4 |
| TiO2 | 2 | 2 | 2 | 2 | 2 | 2 | 2 | 2 | 2 |
| Surfactant 1 | 0.2 | 0.2 | 0.2 | 0.2 | 0.2 | 0.2 | 0.2 | 0.2 | 0.2 |
| KOH | 1.7 | 1.7 | 1.7 | 1.7 | 1.7 | 1.7 | 1.7 | 1.7 | 1.7 |
| CaCO₃ | 0 | 10 | 20 | 30 | 40 | 50 | 60 | 60 | 70 |
| Clay | 0 | 0 | 0 | 0 | 0 | | | | |
| Starch | | | | | | | | 2 | 2 |

| | Before Aging | | | | After Aging at 100 deg. C./22 hrs | | | |
|---|---|---|---|---|---|---|---|---|
| | TS | M300 | M500 | E % | TS | M300 | M500 | E % |
| Exp 38 | 30.35 | 6.02 | 23.29 | 553 | 36.9 | 11.18 | NA | 440 |
| Exp 39 | 23.49 | 5.48 | 16.2 | 586 | 23.86 | 6.7 | NA | 480 |
| Exp 40 | 25.47 | 5.65 | 16.47 | 593 | 22.19 | 8.09 | NA | 407 |
| Exp 41 | 23.69 | 6.16 | 16.89 | 593 | 26.27 | 10.18 | NA | 407 |
| Exp 42 | 20.72 | 6.1 | 14.98 | 580 | 16.43 | 5.2 | NA | 473 |
| Exp 43 | 17.8 | 4.62 | 10.37 | 606 | 14.14 | 5.95 | NA | 420 |
| Exp 44 | 16.67 | 5.84 | 11.02 | 520 | 14.01 | 6.26 | NA | 420 |
| Exp 45 | 13.66 | 5.55 | NA | 480 | 13.43 | 6.73 | NA | 407 |
| Exp 46 | 13.36 | 6.56 | NA | 447 | 9.88 | 5.23 | NA | 413 |

### Example 16—Varying Amount of Soluble Divalent Metal Hydroxide Alone and in Combination with Soluble Trivalent Metal Hydroxide and with Variable Filler and Variable Amount of Biodegrading Material without the Usage of Sulphur and No Accelerators

| | Exp | Exp | Exp | Exp | Exp | Exp | Exp | Exp | Exp | Exp | Exp | Exp | Exp |
|---|---|---|---|---|---|---|---|---|---|---|---|---|---|
| | 47 | 48 | 49 | 50 | 51 | 52 | 53 | 54 | 55 | 56 | 57 | 58 | 59 |
| Nitrile | 100 | 100 | 100 | 100 | 100 | 100 | 100 | 100 | 100 | 100 | 100 | 100 | 100 |
| 1 | | | | | | | | | | | | | |
| SDVM | 0.00 | 0.00 | 0.00 | 0.00 | 0.00 | 0.00 | 0.00 | 0.00 | 0.00 | 0.0 | 0.00 | 0.00 | 0.00 |
| H | 25 | 2 | 25 | 2 | 25 | 2 | 25 | 2 | 25 | 02 | 15 | 1 | 15 |
| AO | 0.2 | 0.2 | 0.2 | 0.2 | 0.2 | 0.2 | 0.2 | 0.2 | 0.2 | 0.2 | 0.2 | 0.2 | 0.2 |
| TiO2 | 2.5 | 2.5 | 2.5 | 2.5 | 2.5 | 2.5 | 2.5 | 2.5 | 2.5 | 2.5 | 2.5 | 2.5 | 2.5 |
| Surfact- | 0.2 | 0.2 | 0.2 | 0.2 | 0.2 | 0.2 | 0.2 | 0.2 | 0.2 | 0.2 | 0.4 | 0.4 | 0.4 |
| ant 1 | | | | | | | | | | | | | |
| KOH | 1.7 | 1.7 | 1.7 | 1.7 | 1.7 | 1.7 | 1.7 | 1.7 | 1.7 | 1.7 | 1.7 | 1.7 | 1.7 |
| CaCO₃ | | | 20 | 20 | 36.5 | 36.5 | 56.5 | 56.5 | 76.5 | 76.5 | 0 | 0 | 20 |
| Starch | | | | | 2 | 2 | 2 | 2 | 2 | 2 | 1 | 1 | 1 |

| | Exp | Exp | Exp | Exp | Exp | Exp | Exp | Exp | Exp | Exp | Exp | Exp |
|---|---|---|---|---|---|---|---|---|---|---|---|---|
| | 60 | 61 | 62 | 63 | 64 | 65 | 66 | 67 | 68 | 69 | 70 | 71 |
| Nitrile | 100 | 100 | 100 | 100 | 100 | 100 | 100 | 100 | 100 | 100 | 100 | 100 |
| 1 | | | | | | | | | | | | |
| SDVM | 0.00 | 0.00 | 0.00 | 0.00 | 0.00 | 0.00 | 0.00 | 0.00 | 0.00 | 0.0 | 0.00 | 0.00 |
| H | 1 | 15 | 1 | 05 | 05 | 15 | 1 | 05 | 15 | 01 | 05 | 05 |
| STVM | | | | | 0.00 | | | 0.00 | | | | |
| H | | | | | 15 | | | 15 | | | 0.05 | 0.05 |
| AO | 0.2 | 0.2 | 0.2 | 0.2 | 0.2 | 0.2 | 0.2 | 0.2 | 0.2 | 0.2 | 0.2 | 0.2 |
| TiO2 | 2.5 | 2.5 | 2.5 | 2.5 | 2.5 | 2.5 | 2.5 | 2.5 | 2.5 | 2.5 | 2.5 | 2.5 |
| Surfact- | 0.4 | 0.4 | 0.4 | 0.4 | 0.4 | 0.4 | 0.4 | 0.4 | 0.4 | 0.4 | 0.4 | 0.4 |
| ant 1 | | | | | | | | | | | | |
| KOH | 1.7 | 1.7 | 1.7 | 1.7 | 1.7 | 1.7 | 1.7 | 1.7 | 1.7 | 1.7 | 1.7 | 1.7 |
| CaCO₃ | 20 | 40 | 40 | | | 60 | 60 | | 80 | 80 | 50 | |
| Starch | 1 | 1 | 1 | | | 1 | 1 | | 1 | 1 | | |

| | Before Aging | | | | After Aging at 100 deg. C./22 hrs | | | |
|---|---|---|---|---|---|---|---|---|
| | TS | M300 | M500 | E % | TS | M300 | M500 | E % |
| Exp 47 | 29.33 | 5.23 | 18.54 | 580 | 33.43 | 3.34 | 8.83 | 660 |
| Exp 48 | 24.95 | 3.59 | 9.3 | 627 | 30.87 | 3.42 | 9.47 | 666 |
| Exp 49 | 23.46 | 5.25 | 13.61 | 593 | 28.78 | 5.43 | 13.95 | 626 |
| Exp 50 | 28.79 | 3.34 | 17.41 | 573 | 30.08 | 5.55 | 14.9 | 606 |
| Exp 51 | 14.8 | 5.3 | 11.8 | 547 | 16.76 | 4.56 | 9.11 | 607 |
| Exp 52 | 15.51 | 5.09 | 11.06 | 581 | 20.49 | 5.42 | 11.62 | 600 |
| Exp 53 | 12.46 | 5.4 | 10.47 | 533 | 15.88 | 5.74 | 11.09 | 573 |
| Exp 54 | 13.29 | 5.6 | 11.12 | 520 | 16.71 | 6.13 | 12.49 | 573 |
| Exp 55 | 10.16 | 4.72 | 7.9 | 553 | 13.17 | 5.99 | 10.51 | 527 |
| Exp 56 | 9.12 | 4.06 | 6.18 | 600 | 11.62 | 4.85 | 8.19 | 587 |
| Exp 57 | 18.15 | 2.25 | 4.52 | 680 | 37.39 | 3.48 | 8.36 | 670 |
| Exp 58 | 17.25 | 2.19 | 4.09 | 707 | 35.15 | 3.07 | 7.62 | 667 |
| Exp 59 | 21.32 | 3.56 | 7.42 | 666 | 32.48 | 5.25 | 11.41 | 647 |
| Exp 60 | 19.13 | 3.25 | 5.93 | 673 | 28.25 | 4.33 | 8.61 | 680 |
| Exp 61 | 12.62 | 3.52 | 5.84 | 680 | 13.3 | 3.7 | 4.03 | 720 |
| Exp 62 | 14.57 | 3.42 | 5.35 | 740 | 17.05 | 3.35 | 5.51 | 700 |
| Exp 63 | 22.19 | 2.33 | 5.05 | 707 | 30.82 | 1.96 | 4.58 | 720 |
| Exp 64 | 20.68 | 2.32 | 4.56 | 720 | 33.9 | 3.03 | 6.47 | 693 |
| Exp 65 | 13.18 | 4.13 | 5.8 | 707 | 14.05 | 4.02 | 6.63 | 707 |
| Exp 66 | 12.33 | 4.19 | 6.45 | 673 | 13.85 | 4 | 6.5 | 687 |
| Exp 67 | 25.07 | 2.82 | 6.38 | 693 | 29.31 | 2.36 | 4.9 | 740 |
| Exp 68 | 11.08 | 4.6 | 6.99 | 627 | 12.26 | 4.38 | 6.51 | 660 |
| Exp 69 | 10.13 | 4.47 | 6.69 | 647 | 11.51 | 4.2 | 5.79 | 707 |
| Exp 70 | 26.1 | 3.4 | 7.65 | 667 | 30.73 | 2.89 | 6.02 | 720 |
| Exp 71 | 16.04 | 5.05 | 9 | 620 | 18.73 | 5.17 | 8.97 | 647 |

| | | | | | After Aging at | | | |
|---|---|---|---|---|---|---|---|---|
| | Before Aging | | | | 100 degrees Celsius/22 hrs | | | |
| | TS | M300 | M500 | E % | TS | M300 | M500 | E % |
| Example 15 | 20.6 | 5.78 | 15.60 | 550.9 | 19.68 | 7.28 | NA | 429.7 |
| Example 16 | 17.7 | 3.96 | 8.36 | 636.6 | 23.06 | 4.22 | 8.48 | 655.6 |

With reference to the data collected in experiment 38-46, the experiment data demonstrate the difference between the power of nano-solubilized divalent metal hydroxide versus the conventional formulation used in example 15.

Experiment 38-46 explains that after aging, none of the results crossed the elongation of 500% whereas the data provided in example 16, nano-solubilized divalent zinc is present in the form of zinc hydroxide, none of the values below 500%, more over 7/25 reading were above 700%, 14/25 Set 15 average is 430% whereas the similar value of set 16 is 655%

In the case of unaged in example 15, none of the experiment data reading crossed 600% elongation, in fact 2 out of 9 show readings below 500%. In the case of example 16, 5 out of 25 readings were above 700% and 12/25 readings were above 600%. Example 15 has an average is 551% whereas the similar value of example 16 is 636%

The curative used in example 16 is as low as 0.0005 parts whereas in example 15 is 1.2 parts which is 2400 times more, apart from that no sulphur or accelerator are used in example 16. If we see the total crosslinking agent used, it is 3.2 parts which is 6400 times higher than the lower level of crosslinking agent used in Example 16.

Example 16 is the center point of invention using solubilized nano downsized divalent metal ion of zinc is involved as zinc hydroxide. Example 16 does not contain any sulphur and sulphur donors. Sulphur donors are also known as accelerators. Example 16 contains solubilized divalent metal ion as hydroxide as low as 0.0005 parts. Example 16 also contains biodegradable material in 16 out of 25 individual experiments.

Example 16 contains experiments having filler up to 0-80 parts. Even with the filler level of 80 parts the after aging elongation goes above 650% or even 700%. This implies that the product upon prolong storage life having good elastomeric property. Experiment 68 and 69 does not contain sulphur or accelerators.

The modulus values of example 16 is substantially lower than the conventionally formulated products. Even though the before aging tensile is lower the after aging tensile is higher than the conventionally formulated product. This indicates the excessive crosslinking agents of ionic and covalent naturally kills the product upon storage.

### Example 17—Multiple Latexes, Soluble Divalent Metal Hydroxide, No Sulphur and No Accelerators

| | Exp 72 |
|---|---|
| Nitrile 1 | 80 |
| PCP-HG | 20 |
| SDVMH | 0.01 |
| AO | 0.2 |
| TiO2 | 2.5 |
| Surfactant 1 | 0.4 |
| KOH | 1.7 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 72 | 26.58 | 4.52 | 14.4 | 587 | 30.65 | 2.93 | 7.55 | 666 |

With regards to experiment 72, this is an example to demonstrate the power of solubilized divalent metal hydroxide. Even without sulphur and other accelerators, with the low phr of 0.01 it give a good property film which comfortably meets the ASTM D 6319 standards, with a blend ratio of 80 NBR:20 Polychloroprene.

### Example 18—Varying Soluble Metal Hydroxide Constant Filler, No Sulphur and Minimal Accelerator

| | Exp 73 | Exp 74 |
|---|---|---|
| Nitrile 2 | 100 | 100 |
| ZnO | 0.25 | 0.25 |
| STVMH | 0.4 | 0.1 |
| ZDBC | 0.05 | 0.05 |
| AO | 0.15 | 0.15 |
| TiO2 | 0.5 | 2 |
| KOH | 1.7 | 1.7 |
| CaCO₃ | 20 | 20 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 73 | 24.66 | 8.05 | NA | 487 | 28.76 | 5.81 | 18.14 | 587 |
| Exp 74 | 122.25 | 2.91 | 6.11 | 1693 | 29.5 | 3.59 | 9.06 | 687 |

Based on the data collected from experiment 73 and 74, gloves with 20 parts filler and 0.4, 0.1 phr soluble trivalent metal hydroxide, the after aging tensile results are meeting the standard. In the case of before aging the 0.1 phr, soluble trivalent metal hydroxide meets the ASTM D 6319 standard requirement but the 0.4 fails in elongation, the excess soluble trivalent metal hydroxide does not help to meet the ASTM D 6319 standard.

### Example 19—Multiple Latexes, Soluble Divalent Metal Hydroxide—No Sulphur—No Accelerator

| | Exp 75 |
|---|---|
| Nitrile 1 | 75 |
| PCP-HG | 25 |
| SDVMH | 0.0025 |
| AO | 0.2 |
| TiO2 | 2.5 |
| Surfactant 1 | 0.4 |
| Surfactant 2 | 0.1 |
| KOH | 1.7 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 75 | 19.5 | 3.08 | 7.6 | 640 | 28.15 | 3.09 | 8.88 | 673 |

Experiment 75 shows a blend of carboxylated nitrile butadiene and polychloroprene without any accelerators and sulphur. Only 0.0025 phr of soluble divalent metal hydroxide is used. The results are considered excellent compared to ASTM D 6319 standards before and after aging.

### Example 20—Constant Soluble Divalent Metal Hydroxide With—No Sulphur—No Accelerator and Multiple Type of Fillers

| | Exp 76 |
|---|---|
| PCP-HG | 100 |
| SDVMH | 0.02 |
| AO | 1.5 |
| TiO2 | 2 |
| Surfactant 2 | 0.75 |
| KOH | 1 |
| CaCO₃ | 10 |
| Clay | 10 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 76 | 11.84 | 2.1 | 4.3 | 747 | 16.03 | 1.55 | 3.42 | 807 |

Curing of polychloroprene normally requires 5 to 8 parts of milled solid divalent zinc oxide. With regards to experiment 76, elastomeric films can be obtained at 0.02 solubilized divalent metal hydroxide, which could be handled even without sulphur and accelerator and other ionic crosslinkers. With regards to this experiment, solubilized divalent metal hydroxide is zinc hydroxide. Upon aging, experiment 76 meets the ASTM D 6319 requirements with no other curatives used.

### Example 21—Combination of Insoluble Divalent Metal Oxide, Soluble Trivalent Metal Hydroxide, Soluble Sulphur, Less Accelerator and Filler

| | Exp 77 |
|---|---|
| Nitrile 2 | 100 |
| ZnO | 0.25 |
| STVMH | 0.1 |
| Sulfur | 0.1 |
| ZDBC | 0.05 |
| DPTT | 0.2 |
| AO | 0.15 |
| TiO2 | 2 |
| KOH | 1.7 |
| CaCO₃ | 20 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 77 | 21.99 | 3.77 | 8.06 | 653 | 21.64 | 3.93 | 10.88 | 647 |

With 20 parts filler and soluble trivalent metal hydroxide of 0.1 and solid divalent oxide of 0.25 with sulphur and accelerator of 0.1 and 0.25 respectively, experiment 77 provides data with good tensile which is almost same in both before and after aging conditions.

### Example 22—Varying High Level of Soluble Divalent Metal Hydroxide and No Other Crosslinking Agents Including Ionic and Covalent (i.e., Free of Sulphur and Accelerator) and Filler

| | EXP 78 | EXP 79 |
|---|---|---|
| PCP-HG | 100 | 100 |
| SDVMH | 0.03 | 0.05 |
| AO | 1.5 | 1.5 |
| TiO2 | 2 | 2 |
| Surfactant 2 | 0.75 | 0.75 |
| KOH | 1 | 1 |
| CaCO₃ | 10 | 10 |
| Clay | 10 | 10 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| EXP 78 | 9.98 | 1.55 | 3.26 | 720 | 15.96 | 1.83 | 3.94 | 820 |
| EXP 79 | 9.81 | 1.76 | 3.84 | 766 | 15.12 | 1.73 | 3.46 | 813 |

With regards to the data collected in experiment 78 and 79, normal curing of polychloroprene requires 5 to 8 parts of milled solid divalent zinc oxide. In this case, at 0.03 and 0.05 solubilized divalent metal hydroxide or zinc hydroxide, upon aging it meets the ASTM D 6319 requirements with no other curatives were used.

### Example 23—Combination of Insoluble Divalent Metal Oxide, Soluble Trivalent Metal Hydroxide, Soluble Sulphur, Less Accelerator and Filler

| | Exp 80 |
|---|---|
| Nitrile 2 | 100 |
| ZnO | 0.25 |
| STVMH | 0.2 |
| Sulfur | 0.1 |
| ZDBC | 0.05 |
| DPTT | 0.2 |
| AO | 0.15 |
| TiO2 | 2 |
| KOH | 1.7 |
| CaCO₃ | 20 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 80 | 26.85 | 5.08 | 13.01 | 647 | 28.72 | 4.52 | 14.28 | 660 |

With regards to experiment 80, the filler level is 20 parts against 100 parts of carboxylated nitrile elastomer with soluble trivalent metal hydroxide and solid divalent metal oxide. The physical properties are good at both before and after aging conditions with elongation around 650%.

### Example 24—Multiple Latexes, Varying Soluble Divalent Metal Hydroxide, Variable Soluble Trivalent Metal Hydroxide, Variable Soluble Sulphur, with and without Accelerator, Variable and Multiple Types of Filler and Biodegradable Material

| | EXP 81 | EXP 82 | EXP 83 | Exp 84 |
|---|---|---|---|---|
| Nitrile 1 | 14.5 | | 20 | 100 |
| Nitrile 2 | | 100 | | |
| PCP | | | 80 | |
| PCP-HG | 100 | | | 10 |
| NR | | | | 10 |
| SDVMH | 0.05 | 0.25 | 0.03 | |
| ZnO | | | 2 | |
| STVMH | | 0.3 | 0.15 | 0.2 |
| Sulfur | | 0.1 | 0.5 | 0.2 |
| ZDBC | | 0.05 | | |
| DPTU | | | 0.2 | |
| DPTT | | 0.2 | 0.3 | 0.1 |
| NaMBT | | | 0.5 | |
| AO | 1.5 | 0.15 | 1 | 0.4 |
| TiO2 | 2 | 2 | 2 | 2 |
| Surfactant 1 | | | 0.2 | 0.5 |
| Surfactant 2 | 0.75 | | 0.3 | 0.25 |
| KOH | 1 | 1.7 | 1.5 | 1.5 |
| CaCO₃ | 10 | 20 | 40 | 40 |
| Clay | 10 | | | |
| Starch | | | 1 | |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| EXP 81 | 9.6 | 1.67 | 3.18 | 780 | 35.5 | 4.95 | 11.93 | 695 |
| EXP 82 | 23.11 | 4.8 | 13.69 | 587 | 55.93 | 10.76 | 32.21 | 647 |
| EXP 83 | 9.41 | 2.22 | 5.25 | 720 | 26.14 | 6.93 | 14.84 | 693 |
| Exp 84 | 17.7 | 4.27 | 9.61 | 640 | 33.7 | 9.04 | 23.17 | 587 |

With regards to experiment 81-84, the filler varies from 20 to 40 with 5 different latex combinations, especially experiment 81, 83 & 84. With 20 parts filler, experiment 82 shows excellent physicals with the combination of soluble trivalent and divalent metal hydroxide. The after aging physical property is excellent with the tensile value of 55.9 MPa. Experiment 81 and 83 due to the presence of polychloroprene show lower physical before aging and higher physical property after aging which is obviously due to improper curing.

### Example 25—Combination of Multiple Latexes, Varying Soluble Divalent Metal Hydroxide, Variable Soluble Trivalent Metal Hydroxide, Variable Soluble Sulphur, Varying Multiple Accelerators, Varying Level of Filler, Varying Biodegrading Agents

| | EXP | EXP | EXP | EXP | EXP | EXP | EXP | EXP | EXP | EXP | EXP | EXP | EXP |
|---|---|---|---|---|---|---|---|---|---|---|---|---|---|
| | 85 | 86 | 87 | 88 | 89 | 90 | 91 | 92 | 93 | 94 | 95 | 96 | 97 |
| Nitrile 1 | 100 | | | | 20 | | | | | 70 | 70 | 100 | 100 |
| Nitrile 2 | | 100 | 100 | | | | 100 | | 100 | | | | |
| Nitrile 3 | | | | 100 | | 100 | | 100 | | | | | |
| PCP | | | | | 80 | | | | | 10 | 10 | | |
| NR | 10 | | 10 | 20 | | 20 | 10 | 20 | 10 | 20 | 20 | | |
| SDVMH | 0.01 | 0.02 | 0.02 | 0.02 | 0.03 | 0.02 | 0.02 | 0.02 | 0.02 | 0.02 | 0.02 | 0.04 | 0.04 |
| ZnO | | | | | 4 | | | | | | 2 | | |
| STVMH | 0.2 | 0.15 | 0.15 | 0.2 | 0.15 | 0.3 | 0.15 | 0.3 | 0.15 | 0.15 | 0.15 | 0.15 | 0.15 |
| Sulfur | 0.2 | 0.2 | 0.4 | 0.25 | 0.5 | 0.25 | 0.4 | 0.25 | 0.4 | 0.4 | 0.4 | 0.4 | 0.4 |
| ZDBC | | | 0.2 | | | | 0.2 | | 0.2 | 0.2 | 0.2 | 0.2 | 0.2 |
| DPTU | | | | | 0.2 | | | | | | | | |
| DPTT | 0.1 | 0.2 | 0.2 | 0.2 | 0.3 | 0.2 | 0.2 | 0.2 | 0.2 | 0.2 | 0.2 | 0.2 | 0.2 |
| NaMBT | | | | 0.2 | 0.5 | 0.2 | | 0.2 | | | | | |
| AO | 0.4 | 0.4 | 0.4 | 0.4 | 1 | 0.4 | 0.4 | 0.4 | 0.4 | 0.4 | 0.4 | 0.4 | 0.4 |
| TiO2 | 2 | 2 | 2 | 2 | 2 | 2 | 2 | 2 | 2 | 2 | 2 | 2 | 2 |
| Surfactant | 0.5 | 0.2 | 0.2 | 0.4 | 0.2 | 0.4 | 0.2 | 0.4 | 0.2 | 0.2 | 0.2 | 0.2 | 0.2 |
| 1 | | | | | | | | | | | | | |
| Surfactant | 0.25 | 0.2 | 0.2 | 0.1 | 0.3 | 0.1 | 0.2 | 0.1 | 0.2 | 0.2 | 0.2 | 0.2 | 0.2 |
| 2 | | | | | | | | | | | | | |
| KOH | 1.5 | 1.5 | 1.5 | | 1.5 | | 1.5 | 1.7 | 1.5 | 1.5 | 1.5 | 1.5 | 1.5 |
| CaCO₃ | 60 | 30 | 50 | 80 | 40 | 100 | 70 | 120 | 90 | 40 | 40 | | 80 |
| Starch | | 1 | 1 | | 1 | | 1 | | | | | 1 | 1 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| EXP 85 | 15.98 | 4.18 | 8.65 | 673 | 35.17 | 10.63 | 24.24 | 627 |
| EXP 86 | 21.87 | 4.21 | 9.81 | 673 | 41.54 | 7.42 | 17.49 | 693 |
| EXP 87 | 14.16 | 3.63 | 8.24 | 567 | 31.9 | 8.29 | 21.26 | 630 |
| EXP 88 | 12.98 | 5.4 | 7.57 | 527 | 27.16 | 10.89 | 23.13 | 580 |
| EXP 89 | 8.4 | 2.2 | 4.7 | 687 | 20.41 | 7 | 15.8 | 627 |
| EXP 90 | 13.75 | 5.85 | 12.3 | 527 | 24.41 | 11.92 | 22.62 | 533 |
| EXP 91 | 14.11 | 5.81 | 13.05 | 533 | 32.95 | 11.72 | 26.09 | 606 |
| EXP 92 | 11.03 | 6.12 | NA | 493 | 11.28 | 4.84 | 8.9 | 593 |
| EXP 93 | 12.87 | 5.65 | 11.93 | 520 | 12.73 | 5.72 | 11.22 | 587 |
| EXP 94 | 13.52 | 4.45 | 11.4 | 570 | 12.95 | 4.09 | 9.45 | 607 |
| EXP 95 | 14.64 | 5.23 | 12.42 | 527 | 13.66 | 4.58 | 10.31 | 593 |
| EXP 96 | 31.83 | 5.16 | 18.02 | 593 | 34.82 | 4.43 | 14.68 | 653 |
| EXP 97 | 14.66 | 7.61 | 14.34 | 520 | 13.85 | 6.01 | 10.74 | 620 |

With regards to the data collected for example 25, the filler quantity varies from 0 to 120 phr. Experiment 96 is without filler but with biodegradable material—the physicals before and after aging are good. Experiment 92 and 90 has the highest filler respectively with 120 and 100 parts against 100 parts nitrile 20 parts of natural rubber. The before aging physicals are inferior but above 10 MPa, however for experiment 90 the after aging results are good.

Experiment 88 and 97 has 80 parts of filler however experiment 88 has additional 20 parts of natural rubber apart from 100 parts of Nitrile. This reflects better after aging physical properties of experiment 88. Experiment 91 has 70 parts filler with additional 10 parts of natural rubber. At such high level of filler the physical properties are good especially after aging. Experiment 85 has 60 parts filler with additional 10 parts of natural rubber. To the level of high filler the physical properties are good especially after aging. Experiment 87 has 50 parts filler with additional 10 parts of natural rubber, hence at such level of filler the physical properties are good especially after aging.

Experiment 89, 94 & 95 has 40 parts filler with different latex combinations. The physicals are not up to the mark, however after aging results of experiment 89 is better, indicating the issue of initial curing. However, the tensile values of both experiment 94, 95 are above 12.5 MPa. Experiment 86 has 30 parts of filler with good physical properties before aging, and excellent properties after aging.

### Example 26—Constant Insoluble Divalent Metal Oxide, Variable Trivalent Metal Hydroxide, Constant Soluble Sulphur, Constant Low Level of Accelerator and Varying Filler Levels

| | Exp | Exp | Exp | Exp | Exp | Exp | Exp | Exp |
|---|---|---|---|---|---|---|---|---|
| | 98 | 99 | 100 | 101 | 102 | 103 | 104 | 105 |
| Nitrile 2 | 100 | 100 | 100 | 100 | 100 | 100 | 100 | 100 |
| ZnO | 0.25 | 0.25 | 0.25 | 0.25 | 0.25 | 0.25 | 0.25 | 0.25 |
| STVMH | 0.2 | 0.3 | 0.4 | 0.5 | 0.3 | 0.4 | 0.2 | 0.2 |
| Sulfur | 0.2 | 0.2 | 0.2 | 0.2 | 0.2 | 0.2 | 0.2 | 0.2 |
| ZDBC | 0.05 | 0.05 | 0.05 | 0.05 | 0.05 | 0.05 | 0.05 | 0.05 |
| AO | 0.15 | 0.15 | 0.15 | 0.15 | 0.15 | 0.15 | 0.15 | 0.15 |
| TiO2 | 2.5 | 2.5 | 2.5 | 2.5 | 2.5 | 2.5 | 2.5 | 2.5 |
| Surfactant 1 | 0.2 | 0.2 | 0.2 | 0.2 | 0.2 | 0.2 | 0.2 | 0.2 |
| Bentonite | 0.4 | 0.4 | 0.4 | 0.4 | 0.4 | 0.4 | 0.4 | 0.4 |
| NH₄OH | 0.1 | 0.1 | 0.1 | 0.1 | 0.1 | 0.1 | 0.1 | 0.1 |
| KOH | 1.7 | 1.7 | 1.7 | 1.7 | 1.7 | 1.7 | 1.7 | 1.7 |
| CaCO₃ | 20 | 20 | 20 | 20 | 25 | 25 | 15 | 25 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 98 | 25.74 | 3.74 | 9.72 | 680 | 7.62 | 4.71 | 12.54 | 647 |
| Exp 99 | 22.06 | 3.73 | 9.03 | 640 | 31.12 | 5.09 | 12.43 | 680 |
| Exp 100 | 26.24 | 5.99 | 15.79 | 633 | 29.99 | 6.89 | 19..52 | 647 |
| Exp 101 | 22.9 | 4.45 | 11.36 | 640 | 35.7 | 6.76 | 17.84 | 653 |
| Exp 102 | 19.74 | 3.58 | 8.13 | 700 | 26.01 | 4.2 | 9.44 | 733 |
| Exp 103 | 19.83 | 4.64 | 10.82 | 640 | 24.77 | 5.78 | 15.14 | 660 |
| Exp 104 | 28.99 | 4.42 | 13.52 | 647 | 33.32 | 4.91 | 14.12 | 640 |
| Exp 105 | 25.29 | 4.48 | 11.25 | 666 | 26.29 | 4.7 | 12.49 | 655 |

Based on the data collected from experiment 98-105, all other compositions are the same except soluble trivalent metal hydroxide and filler. The soluble trivalent metal hydroxide varied from 0.2 to 0.5 phr and the filler varied from 15 to 25 phr. Before aging condition the strength was maximum with low level of soluble trivalent metal hydroxide and filler. At after aging condition the strength was highest with high levels of soluble trivalent metal hydroxide. The highest elongation and lowest M500 in both before aging and after aging condition was attained at 0.3 phr of soluble trivalent metal hydroxide and high amount of filler—25 phr. However, all the experimental data display results well above the ASTM D 6319 requirements.

### Example 27—Combination of Variable Soluble Divalent Metal Hydroxide, No Solid Divalent Metal Oxide, with and without Soluble Trivalent Metal Hydroxide, Constant Soluble Sulphur and Less Accelerator, Variable High Level of Filler

| | Exp 106 | Exp 107 | Exp 108 |
|---|---|---|---|
| Nitrile 2 | 100 | 100 | 100 |
| SDVMH | 0.002 | 0.004 | 0.004 |
| STVMH | | | 0.2 |
| Sulfur | 0.05 | 0.05 | 0.05 |
| ZDBC | 0.05 | 0.05 | 0.05 |
| AO | 0.15 | 0.15 | 0.15 |
| TiO2 | 2.5 | 2.5 | 2.5 |
| Surfactant 1 | 0.2 | 0.2 | 0.2 |
| KOH | 1.7 | 1.7 | 1.7 |
| CaCO₃ | 50 | 75 | 100 |
| Starch | 1 | 1 | 1 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 106 | 16.02 | 3.68 | 6.82 | 733 | 16.2 | 3.7 | 7.46 | 666 |
| Exp 107 | 11.57 | 4.47 | 7.08 | 653 | 14.08 | 5.86 | 10.18 | 627 |
| Exp 108 | 10.21 | 6.34 | NA | 460 | 12.61 | 8.12 | NA | 460 |

Based on the data collected for experiment 106-108, with the exception of soluble divalent and trivalent and filler, other compositions are same. At the phr level of 0.002 and in the absence of soluble trivalent metal hydroxide, the elongation and modulus values are excellent at 50 phr filler. The properties of the glove in said experiment 106 meet the ASTM D 6319 requirements. Experiment 108 contains 100 phr filler, the glove does not meet the ASTM D 6319 requirement however it could be used for other low-cost applications. Experiment 107 containing 75 phr filler performs better than the glove prepared in experiment 108 but still not meeting the ASTM D 6319 standard

### Example 28—Combination of High Strength Latex, Variable Soluble Trivalent Metal Hydroxide, Constant Soluble Sulphur and Less Accelerator, High Level of Filler

| | Exp 109 | Exp 110 |
|---|---|---|
| Nitrile 1 | 100 | 100 |
| ZnO | 0.4 | 0.4 |
| STVMH | 0.15 | 0.25 |
| Sulfur | 0.15 | 0.15 |
| ZDBC | 0.05 | 0.05 |
| AO | 0.05 | 0.05 |
| TiO2 | 0.33 | 0.33 |
| Surfactant 1 | 0.1 | 0.1 |
| Bentonite | 0.33 | 0.33 |
| NH₄OH | 0.05 | 0.05 |
| KOH | 1.5 | 1.5 |
| CaCO₃ | 50 | 75 |

| | | | | | After Aging at | | | |
|---|---|---|---|---|---|---|---|---|
| | Before Aging | | | | 100 deg. C./22 hrs | | | |
| | TS | M300 | M500 | E % | TS | M300 | M500 | E % |
| Exp 109 | 17.4 | 6.13 | 13.17 | 607 | 23.12 | 6.97 | 15.07 | 606 |
| Exp 110 | 17.8 | 7.44 | 13.68 | 620 | 14.53 | 5.8 | 10.98 | 593 |

Based on the data collected from experiment 109-110, with the exception of soluble trivalent metal hydroxide and filler, all others are constant. Even with 75 phr of filler, elongation above 600% and tensile strength obtained barely meet the ASTM D 6319 standard requirement. With 50 phr of filler, the tensile after aging is good at 23 MPa.

I/We claim:

1. A method to manufacture an elastomeric article comprising:
preparing a former for shaping the elastomeric article;
dipping the former into a coagulant solution, wherein the coagulant solution comprising one or more polyvalent metal salt, surfactant, wetting agents, anti-tack materials, non-settling agents, and biocide;
dipping the coagulant-coated former into a synthetic latex composition comprising one or more elastomeric polymer, curatives, fillers, surfactants, non-settling agents and biocides, from 20° C. to 40° C. at least once to create the elastomeric article;
pre-leaching the elastomeric article for not more than 10 times;
vulcanizing the elastomeric article to enable effective crosslinking;
vulcanization temperature of the elastomeric article ranges from 60° C. to 140° C.;
post-leaching the elastomeric article at temperature of 30° C. to 95° C.;
applying donning aid to the elastomeric article;
drying the elastomeric article; and
stripping the elastomeric article from the former;
wherein the fillers comprising organic fillers and/or inorganic fillers,
wherein the inorganic fillers comprise one or more non siliceous inorganic filler up to 75 phr and/or one or more siliceous inorganic filler up to 30 phr,
wherein said elastomeric article has a thickness of 0.001 to 5 mm, a minimum tensile strength of 7 MPa, and an elongation above 300%.

2. The method of claim 1, further comprising cleaning the former at a temperature up to 100 degrees Celsius before said dipping thereof into the coagulant solution.

3. The method of claim 1, wherein said dipping the former into the coagulant is repeated for 1 to 8 times.

4. The method of claim 3, wherein said dipping the former into the coagulant once followed by said dipping into the synthetic latex composition.

5. The method of claim 3, further comprising drying the coagulant-coated former after said dipping the former into the coagulant and prior to said dipping into the synthetic latex composition.

6. The method of claim 3, wherein said dipping into the coagulant for more than 1 time increases thickness of the resulting elastomeric article.

7. The method of claim 1, wherein said pre-leached elastomeric article is at a temperature between 30-70 degrees Celsius and is optionally polymer coated.

8. The method of claim 1, wherein said the beaded elastomeric is vulcanized and optionally chlorinated

9. The method of claim 8, wherein the vulcanized elastomeric article is neutralized and post leached.

10. The method of claim 9, wherein the vulcanized and neutralized elastomeric article is coated with donning aids and dried to remove moisture adhering to the article.

11. The method of claim 1, wherein said elastomeric article is stripped off manually or mechanically.

12. The method of claim 1, wherein the curatives are prepared by treating a multivalent oxide form of the metal into an excessive alkaline solution, wherein the alkaline solution comprises at least a combination of sodium and potassium hydroxides to stabilize the pH of the subsequent latex composition and to make more free metal ions.

13. The method of claim 12, wherein the sodium or potassium forms an intermediate sodium or potassium compound, and wherein the multivalent oxide form of the metal comprises divalent zinc oxide.

14. The method of claim 13, wherein the polyvalent metal comprises one or both of divalent zinc hydroxide, and the intermediate sodium and or potassium compound is sodium zincate and or potassium zincate.

15. The method of claim 12, wherein ratio of the multivalent metal oxide:sodium hydroxide:potassium hydroxide is 1:3:2.

16. The method of claim 15, wherein the multivalent metal oxide is mixed with the alkaline material under 120 degrees Celsius, followed by cooling and subsequently dissolving in water to yield a partially soluble polyvalent metal hydroxide.

17. The method of claim 16, wherein the soluble polyvalent metal hydroxide is maintained at a pH above 10.

18. The method of claim 1, wherein the former is a copolymer consisting of carboxylic acid or derivatives thereof and butadiene building block either alone or in combination with nitrile butadiene, chlorobutadiene, isoprene, styrene butadiene and others conjugated with basic butadiene.

19. An elastomeric article prepared according to the method of claim 1, wherein the treated divalent zinc oxide or similar multivalent metal oxide reduces chemical consumption which permits additional loading of the fillers for easy biodegradation by architectured film matrix, optimizing the strength, modulus and elongation of the article.
